(19) United States
(12) Patent Application Publication
(10) Pub. No.: US 2007/0232244 A1
(43) Pub. Date: Oct. 4, 2007

(54) Method of spatial band reuse in a multi-band communication system

(76) Inventors: Shaomin Samuel Mo, Monmouth Junction, NJ (US); Alexander D. Gelman, Smallwood, NY (US)

Correspondence Address: RATNERPRESTIA, P.O. BOX 980, VALLEY FORGE, PA, 19482, US

(21) Appl. No.: 11/395,090

(22) Filed: Mar. 31, 2006

(51) Int. Cl. H04B 1/02

(52) U.S. Cl. 455/91

(57) ABSTRACT

A method of band multiplexing communications from a plurality of devices includes a rotation being established, by each device, between or among a plurality of frequency bands for transmission. A symbol set is transmitted from each device in each of the established transmission frequency bands and one device detects respective starting times of symbol sets for the other devices transmitting for one of the plurality of frequency bands. A starting time of a symbol set for the one device is selected based on the detected starting times for the other devices such that the selected start times limit interference between symbol sets transmitted by the one device and symbol sets transmitted by the other devices to less than a threshold level. The starting time of respective symbols is adjusted by the one device in subsequent transmissions for each of the established transmission frequency bands based on the selected starting time.

### FIELD OF THE INVENTION

The present invention relates to the field of wireless communications and, more particularly, to a method of band reuse in a multi-band communication system.

### BACKGROUND OF THE INVENTION

Ultra Wideband (UWB) technology uses base-band pulses of very short duration to spread the energy of transmitted signals very thinly from near zero to several GHz. This technology is presently in use in military applications. Commercial applications will soon become possible due to a recent Federal Communications Commission (FCC) decision that permits the marketing and operation of consumer products incorporating UWB technology.

UWB was under consideration by the Institute of Electrical and Electronic Engineers (IEEE) as an alternative physical layer technology. See IEEE 802.15.3a, which was intended for home wireless audio/video systems. Under 802.15.3a, UWB systems are assumed to operate in an environment of uncoordinated piconets. Piconets, sometimes referred to as personal area networks (PANs), are formed when at least two devices, such as a portable PC and a cellular phone, connect over a short distance.

Packet error rates (PER) can be attributed to narrow band interference (NBI) and to collision of packets (i.e., symbols or information bits) transmitted on common communication (e.g., frequency) bands. “Multi-band” modulation technologies have been developed for UWB communication systems to deal with NBI. In multi-band UWB communication systems, the UWB frequency band is divided into multiple sub-bands utilizing a different spreading waveform in each of the sub-bands. One of the advantages of a multi-band UWB system is its ability to work in environments having NBI. When NBI is detected, multi-band UWB systems may automatically shut down the corresponding sub-bands shared with the NBI to reduce the effect of the NBI. Time/frequency hopping may be utilized in multi-band UWB systems to further reduce NBI effects.

FIG. 1 is a conceptual representation of a multi-band spectrum allocation for a UWB communication system which is in accordance with FCC mandates for such systems. The UWB spectrum of 7.5 GHz in the 3.1 GHz to 10.6 GHz frequency band is divided into 14 bands and each of these bands 1-14 occupies 528 MHz of bandwidth. Bands 1-14 are grouped into band groups 1-5. For devices using UWB communication support for band group 1 is mandatory while it is optional for band groups 2-5.

FIG. 2A is a data diagram of a conventional superframe used for communication among a plurality of UWB devices in the UWB communication system.

FIG. 2B is an exemplary grouping of the UWB devices. Although 3 UWB devices are shown, any number of devices may be included in the UWB communication system.

Referring now to FIGS. 2A and 2B, the basic timing structure for data exchange is a superframe (e.g., 200, 201 and 202). Each superframe 200, 201 and 202 comprises (1) a beacon period (BP) 210, which is used to set timing allocations and to communicate management information for the piconet; (2) a priority channel access (PCA) period 220, which is a contention-based channel access that is used to communicate commands and/or asynchronous data; and (3) a distributed reservation protocol (DRP) period 230, which enables UWB devices A, B and C to reserve reservation blocks 240-1, 240-2 . . . 240-N outside of BP 210 of superframes 200, 201 and 202. DRP period 230 may be used for commands, isochronous streams and asynchronous data connections. Reservations made by UWB devices A, B and C specify one or more reservation blocks 240-1, 240-2 . . . 240-N they may use to communicate with one or more other UWB devices A, B and C on the piconet. UWB devices A, B and C using DRP period 230 for transmission or reception may announce reservations by including DRP Information Elements (IEs) in their beacons.

Each UWB device A, B and C may reserve an integral number of reservation blocks 240-1, 240-2 . . . 240-N (e.g., reservations may be made in units of reservation blocks or Media Access Slots (MASs). UWB devices A, B and C may reserve multiple reservation blocks which may not be consecutive. That is, these multiple reservation blocks may have portions which are consecutive and other portions which are not consecutive. UWB devices A, B and C may reserve excess reservation blocks for error correction relevant retransmission and other control data, among others. Each UWB device A, B and C may start transmission at the beginning of a respective reserved reservation block.

Each reservation block 240-1, 240 . . . 240-N may include a plurality of frames 260 and may include intra-frame periods 270 and 280 such as MIFS periods, SIFS periods and a Guard period, among others. Conventionally, these intra-frame periods 270 and 280 are fixed duration periods, for example, under the WiMedia ECMA-368 standard, the MIFS period is 1.875 ηs, the SIFS period is 10 μs, and the Guard period is 12 μs. These intraframe periods may vary in different UWB multi-band conventional systems.

UWB devices A, B and C may simultaneously transmit symbols (i.e., information bits) during frames 260 using Orthogonal Frequency Division Multiplexing (OFDM) modulation. Symbols may be interleaved across various bands to exploit frequency diversity and provide robustness against multi-path interference.

A simultaneously operating piconet (SOP) refers to, for example, multiple UWB devices A, B and C which may operate in different piconets in a common coverage area 20. When these UWB devices A, B and C are used in apartment buildings, for example, the probability is high that multiple overlapping SOPs are operating. One challenge for communication systems is dealing with interference caused by multiple SOPs that operate nearby. One method for minimizing interference among SOPs is to assign each SOP a different TFC (i.e., channel).

Each UWB device may have a transmitter 285, a receiver 286, a processor 287, and an antenna 288. Transmitter 285 transmits and receiver 286 receives symbols according to the established TFC. Moreover, processor 287 controls processing within each UWB device.

FIG. 3A is a chart illustrating a conventional time-frequency code for band groups 1-4 illustrated in FIG. 1. For each band group 1-4, channels 1-7 may be established such that UWB device A may communicate over channel 1, UWB device B may communicate over channel 2 and UWB device C may communicate over channel 3. That is, for example, (1) in a first symbol period T1, UWB devices A, B, and C may communicate over frequency band 1; (2) in a second symbol period T2, UWB device A may communicate over frequency band 2, UWB device B may communicate over frequency band 3, and UWB device C may communicate over frequency band 1; (3) in a third symbol period T3, UWB device A may communicate over frequency band 3, and UWB devices B and C may communicate over frequency band 2. Each channel may have a unique time/frequency hopping scheme, also referred to as a time-frequency code (TFC).

To support multiple SOPs and avoid interference, the information bits (i.e., symbols) are spread using the TFC. Typically, two types of TFCs are used: ones in which symbols are interleaved over multiple bands, referred to as Time-Frequency Interleaving (TFI); and other ones in which symbols are transmitted on a single band, referred to as Fixed Frequency Interleaving (FFI). Typically, each of the band groups 1-4 support both TFI and FFI.

For example, UWB devices assigned the conventional TFC shown in FIG. 3A may communicate over channels 1-4 using TFI, while other UWB devices may communicate over channels 5-7 using FFI and may completely avoid collision. However, because all symbols from a UWB device using, for example, channel 5 are transmitted on frequency band 1, total transmission power for frequency band 1 from the one UWB device is 4.7 dB higher than if distributed over frequency bands 1-3. Correspondingly, the FCC mandates that transmitters on channels 5-7, be required to reduce transmission power by 4.7 dB which results in a reduced coverage range.

FIG. 3B is a timing chart illustrating the transmission of symbols from UWB device A using the TFC of FIG. 3A.

Referring now to FIG. 3B, UWB device A may transmit symbols A1-A6 in a frequency hopping scheme based on channel C1 of the TFC of FIG. 3A. Each symbol includes an IFFT output 290 and a zero-padded suffix 295. The duration L1 of each symbol is 312.5 ns and is composed of 165 samples. The duration of the IFFT Output is 242.42 ns and is composed of 128 samples. The duration of the zero-padded suffix is 70.08 ns and is composed of 37 samples. Each symbol contains information bits which are transmitted between UWB device A via frequency bands 1, 2 or 3 and other UWB devices. Moreover, the zero-padded suffix 295, generally, includes redundant information bits, for example, which may be used for error correction.

### SUMMARY OF THE INVENTION

The present invention is embodied in a control method of band multiplexing communications from a plurality of devices. The control method includes establishing a rotation by each device, between or among a plurality of frequency bands for transmission. The method further includes transmitting a symbol set from each device in each of the established transmission frequency bands and one device detecting respective starting times of symbol sets for the other devices in one of the plurality of frequency bands. A starting time of a symbol set of the one device is selected based on the detected starting times for the other devices such that the selected start times limit interference between symbol sets transmitted by the one device and symbol sets transmitted by the other devices to less than a threshold level. The starting time of respective symbols is adjusted by the one device in subsequent transmissions for each of the established transmission frequency bands based on the selected starting time.

The present invention is embodied in a control method of band multiplexing communications from a plurality of devices in a communication system. The control method includes a rotation being established, by each device, between or among a plurality of frequency bands for transmission. The method further includes at least one respective device transmitting a symbol set in each of the established transmission frequency bands and a further device detecting the starting times of symbol sets for one of the plurality of frequency bands for each of the respective devices transmitting in the communication-system. The further device determines whether to transmit using the plurality of frequency bands according to the detected starting times of symbol sets for each of the respective devices transmitting on the plurality of frequency bands. Responsive-to the further device transmitting, it selects a starting time of a symbol set for the one frequency band used for detection such that overlap of symbol set periods for the further device and any of the respective devices transmitting is limited to less than a predetermined threshold level.

The present invention is embodied in a control method of band multiplexing communications from a plurality of devices in a communication system. The control method includes establishing a rotation by each device, between or among a plurality of frequency bands for transmission. The communication system includes a plurality of frequency band groups. The method further includes at least one respective device of the plurality of devices transmitting a symbol set in a respective frequency band group of the plurality of frequency band groups in each of the established transmission frequency bands and a further device of the plurality of devices detecting the starting times of symbol sets of the respective device for one frequency band of the plurality of frequency bands in the respective frequency band group. The further device determines whether to transmit using the one respective frequency band group according to the detected starting times of symbol sets of the respective device transmitting on the one frequency band in the one respective frequency band group. Responsive to the further device not transmitting using the one respective frequency band group, repeating the detection and determination steps until the further device determines that a further one of the plurality of frequency band groups is to be used for transmission of symbol sets. Responsive to the further device transmitting using the further one of the plurality of frequency band groups, the further device selects a starting time of a symbol set for a respective frequency band of the further one of the plurality of frequency band groups such that overlap of symbol set periods of symbol sets for the further one of the plurality of frequency bands is limited to less than a predetermined threshold period.

The present invention is embodied in a device for communicating with at least one other device and includes a processor for establishing the rotation between or among a plurality of frequency bands, a transmitter for transmitting a symbol set in each of the established transmission frequency bands and a receiver for detecting respective starting times of transmitted symbol sets from the at least one other device for one of the plurality of frequency bands. The processor selects a starting time of a symbol set to be transmitted based on the detected starting times of symbol sets of the other device, and controls the adjustment of the starting time by the transmitter in subsequent transmissions of respective symbols for each of the established transmission frequency bands based on the selected starting time. The selected start time is selected to limit interference between symbol sets transmitted by the device and the symbol sets transmitted by the other device to less than a threshold level.

### BRIEF DESCRIPTION OF THE DRAWINGS

The invention is best understood from the following detailed description when read in connection with the accompanying drawings. It is emphasized that, according to common practice, various features/elements of the drawings may not be drawn to scale. On the contrary, the dimensions of the various features/elements may be arbitrarily expanded or reduced for clarity. Moreover in the drawings, common numerical references are used to represent like features/elements. Included in the drawing are the following figures:

FIG. 1 (Prior Art) is a conceptual representation of a multi-band spectrum allocation for a UWB communication system which is in accordance with FCC mandates for such systems;

FIG. 2A (Prior Art) is a data diagram of a conventional superframe used for communication among a plurality of UWB devices in the UWB communication system;

FIG. 2B (Prior Art) is an exemplary grouping of the UWB devices. Although 3 UWB devices are shown, any number of devices may be included in the UWB communication system;

FIG. 3A (Prior Art) is a chart illustrating a conventional time-frequency code for band groups 1-4 illustrated in FIG. 1;

FIG. 3B (Prior Art) is a timing chart illustrating the transmission of symbols from UWB device A using the TFC of FIG. 3A;

FIG. 4A is a chart illustrating exemplary time-frequency codes (TFC) in accordance with various exemplary embodiments of the present invention and represents one exemplary band group of a plurality of band groups;

FIG. 4B is a data diagram illustrating a distributed reservation protocol (DRP) used in various embodiments of the present invention;

FIG. 4C is an exemplary grouping of the UWB devices in accordance with an embodiment of the present invention;

FIG. 5 is a timing diagram illustrating an exemplary communication from UWB devices using the TFCs shown in FIG. 4A according to an embodiment of the present invention;

FIG. 6 is a timing chart illustrating collisions between two UWB devices in a multi-band communication system when the UWB devices have slightly unsynchronized clock timing;

FIG. 7 is a generalized timing diagram illustrating timing of symbols for two UWB devices in a multi-band communication system in accordance with various exemplary embodiments of the present invention when the UWB devices have synchronized clock timing;

FIG. 8 is a timing diagram illustrating timing of symbols for two UWB devices in a multi-band communication system in accordance with various exemplary embodiments of the present invention when the UWB devices have slightly unsynchronized clock timing;

FIG. 9 is a timing chart illustrating the use of conventional MAS periods with UWB devices A and B using channels C1 and C3 of TFC of FIG. 4A to illustrate the problem of misalignment of symbol due to the conventional MAS periods;

FIG. 10 is a timing diagram illustrating MAS periods that are set to a frequency hopping repeat period or an integer multiple thereof to enable synchronization (alignment) of symbols within a super frame (i.e., across MAS boundaries);

FIG. 11 is a timing chart illustrating the use of a conventional intraframe period 270 with UWB devices A and B using channels C1 of the TFC of FIG. 4A, with a one symbol offset for UWB device B relative to UWB device A to illustrate the problem of misalignment of symbols due to this conventional intraframe period;

FIG. 12 is a timing chart illustrating symbol alignment for symbol set of two symbols (i.e., when M=2) when the intraframe period is 6 symbols (i.e., equal to the frequency hopping repeat period;

FIG. 13 is a timing chart illustrating frequency hopping repeat periods and symbol starting times relative to each frequency hopping repeat period;

FIGS. 14A and 14B are graphs illustrating the relationship between SIR level and SST for 2 different situations;

FIGS. 15A and 15B are schematic diagrams illustrating band reuse with a conventional SIR-based UWB communication system;

FIG. 15C is schematic diagram illustrating a band reuse method for a UWB communication system according to yet another exemplary embodiment of the present invention;

FIG. 15D is a timing chart illustrating the operation of the communication system of FIG. 15C;

FIGS. 16A-16B are timing charts illustrating SST adjustments to align symbols from UWB devices A and B of two different piconets according to yet another embodiment of the present invention;

FIG. 16C is a timing chart illustrating the insertion of a UWB device C from a third piconet C to piconets A and B of FIG. 16B in which UWB device C may cause collisions to UWB devices of either A or B or possibly both A and B;

FIG. 17 is a flow chart illustrating a control method of band multiplexing communication in accordance with yet another embodiment of the present invention;

FIG. 18 is a flow chart illustrating a control method of band multiplexing communication in accordance with yet another embodiment of the present invention;

FIG. 19 is a flow chart illustrating a control method of band multiplexing communication in accordance with yet another embodiment of the present invention;

FIG. 20 is a flow chart illustrating the detection operation of FIGS. 17-19 in accordance with various exemplary embodiments of the present invention;

FIG. 21 is a flow chart illustrating the detection operation of FIGS. 17-19 in accordance with various exemplary embodiments of the present invention; and

FIG. 22 is a flow chart illustrating the detection operation of FIGS. 17-19 in accordance with various exemplary embodiments of the present invention.

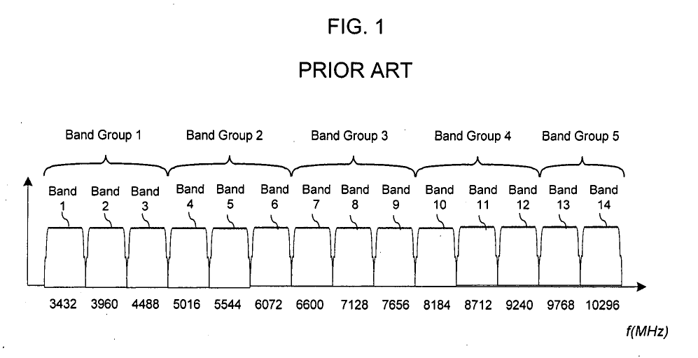

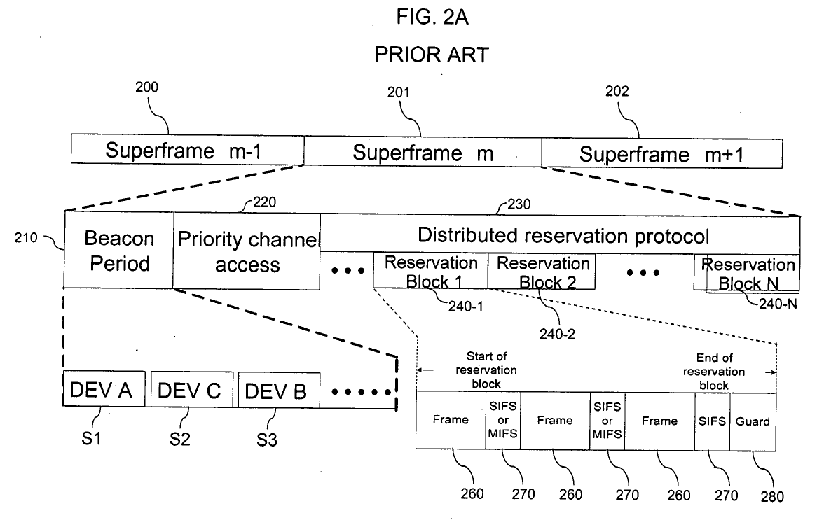

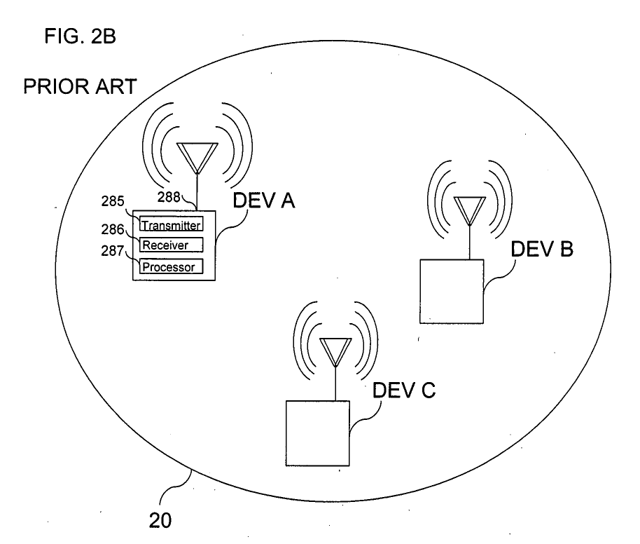

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

UWB communication systems, which may include UWB devices A, B and C are generally known in the art, for example, as illustrated and disclosed in a U.S. application invented by the Inventors of this application, and entitled “METHOD OF BAND MULTIPLEXING TO IMPROVE SYSTEM CAPACITY FOR A MULTI-BAND COMMUNICATION SYSTEM,” and in an industry association standard entitled “Standard ECMA-368, High Rate Ultra Wideband PHY and MAC Standard, published December 2005.”

Although the present invention is described in terms of UWB communication systems, it may be applied to other communication systems such as non-UWB frequency-hopping and time-hopping communication systems. For example, it is contemplated that embodiments of the present invention may be applicable generally to multi-band communication systems. In such a system, by implementing symbol level band multiplexing (i.e., aligning piconets in a coverage area) improved band reuse methods may be realized. More particularly, synchronizing symbols between UWB devices using a particular band group enables reuse of unused time slots of each frequency band in the band group and further enables timing adjustments to open other time slots of these frequency bands for reuse.

The synchronization of such UWB devices may be accomplished by determining the starting times of symbols of each UWB device on a frequency band and adjusting the starting times of each UWB device to reduce latency periods (i.e., gaps) between symbols of UWB devices on the frequency band while also preventing overlaps of these symbols.

According to certain exemplary embodiments, one or more UWB devices may determine whether to join a band group based on the detection of the starting time of the other UWB devices using the band group and whether collisions of symbols will occur if the UWB device joins the band group.

Clock timing adjustments generally refer to clock synchronization adjustments caused by mismatch of clock rate (skew).

It should be understood that the methods illustrated may be implemented in hardware, software, or a combination thereof. In such embodiments, the various components and steps described below may be implemented in hardware and/or software.

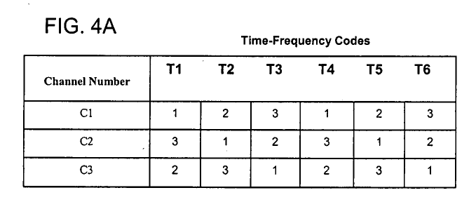

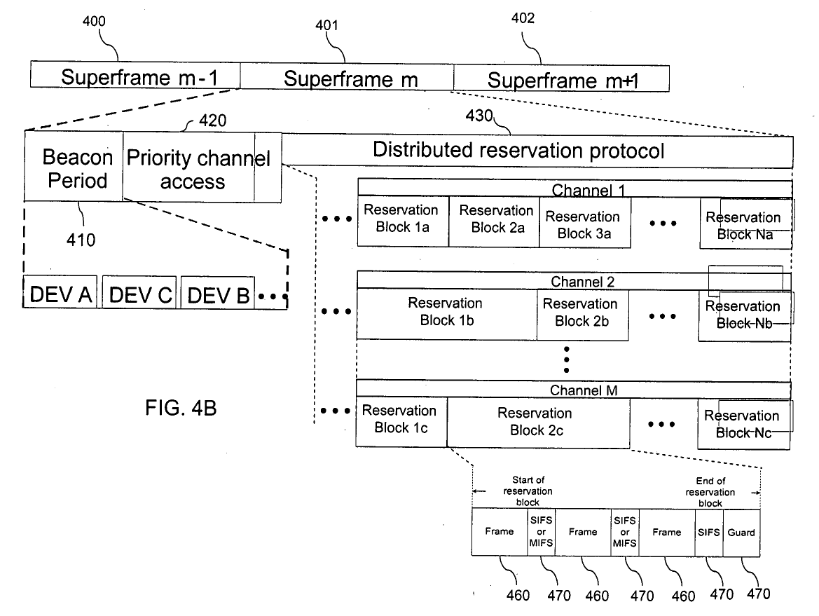

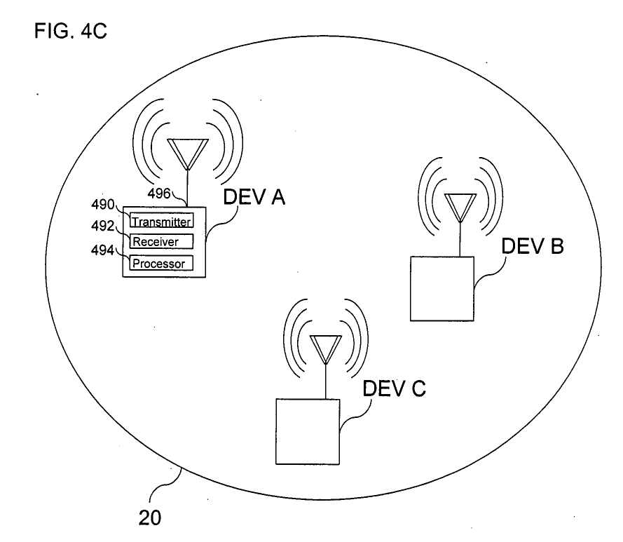

It should also be understood that different UWB devices may operate on different channels in a single SOP or different UWB devices may operate on one or more channels corresponding to a plurality of SOPs under the condition that different SOPs operate on different channels. That is, any particular UWB device may operate on any SOP or any channel, however, each SOP operates on a separate channel. An example of such an arrangement is illustrated below with respect to FIGS. 4A and 4B.

FIG. 4A is a chart illustrating exemplary time-frequency codes (TFC) in accordance with various exemplary embodiments of the present invention and represents one exemplary band group of a plurality of band groups.

FIG. 4A depicts an exemplary time-frequency hopping scheme (e.g., TFC). For each band group, the TFC may be established to prevent collisions between or among transmissions from two or more UWB devices A, B and C. For example, channels C1, C2 and C3 may be established such that UWB device A, B and C may simultaneously communicate over different channels while, in a synchronized manner, repeatedly frequency hopping to other frequency bands 1-3. That is, for example as shown in FIG. 4A: (1) in a first symbol period Ti, UWB device A may communicate over frequency band 1, UWB device B may communicate over frequency band 3 and UWB device C may communicate over frequency band 2; (2) in a second symbol period T2, UWB device A may communicate over frequency band 2, UWB device B may communicate over frequency band 1 and UWB device C may communicate over frequency band 3; and (3) in a third symbol period T3, UWB device A may communicate over frequency band 3, UWB device B may communicate over frequency band 2, and UWB device C may communicate over frequency band 1. The communications from UWB devices may be in one or more SOPs according to channel assignments.

It is understood that such a TFC represents a rotation of the frequencies bands for transmission of symbols. That is, one set of symbols (i.e., one or more symbols) may be transmitted for each respective UWB device A, B and C on a corresponding frequency band, the transmission frequency of each UWB device may be adjusted to a next corresponding frequency band and another respective set of symbols for each respective UWB device may be further transmitted on the next corresponding frequency band. This process may be repeated until communication from each UWB device is completed. Moreover, the repeated adjustment of the transmission frequency of each UWB device to each next corresponding frequency band may be coordinated between or among the plurality of UWB devices A, B and C (e.g., the piconets may be aligned) based on which TFCs are predefined. The coordination of transmission of the plurality of UWB devices A, B and C may include the establishment of a logical succession of the plurality of frequency bands for transmission such that adjustment of the transmission frequency band of each UWB device occurs by following the established logical succession.

It is further understood that certain frequency bands may be rendered inactive due to NBI and the TFC may be dynamically changed to accommodate such interference.

As illustrated in FIG. 4A, the number of SOPs is equal to the number of frequency bands. It is contemplated, however, that any number of SOPs may be simultaneously active, but desirably less than the number of frequency bands in the band group to reduce or substantially eliminate collisions between transmissions from the UWB devices in these SOPs.

FIG. 4B is a data diagram illustrating a distributed reservation protocol (DRP) used in various embodiments of the present invention.

Now referring to FIG. 4B, DRP 430 may include simultaneous reservation blocks for respective channels 1-M, for example, of the TFC shown in FIG. 4A. Each UWB device A, B and C may reserve a reservation block 1a, 2a . . . Na; 1b, 2b . . . Nb; or 1c, 2c . . . Nc of a respective channel 1-M. UWB devices A, B and C on different channels may be in the same SOP or different SOPs, as an example, UWB device A may be in a first SOP related to channel 1 of the TFC of FIG. 4A, UWB device B may be in a second SOP related to channel 2 of the TFC of FIG. 4A, UWB device C may be in a third SOP related to channel 3 of the TFC of FIG. 4A. In such a case, UWB device A may reserve, in the beacon period, one or more reservation blocks 1a, 2a . . . Na of channel 1, UWB device B may reserve, in the beacon period, one or more reservation blocks 1b, 2b . . . Nb of channel 2 and UWB device C may reserve, in the beacon period, one or more reservation blocks 1c, 2c . . . Nc of channel M. These respective reservation blocks may be simultaneous (i.e., having portions occurring at the same time), and/or may having different starting and ending points (i.e., may be offset in time). Na, Nb and Nc may be equal or unequal. In the exemplary embodiment shown in FIG. 4B, Na, Nb and Nc are all equal. The total length of all channels is the same, equal to the length of a superframe.

Collisions may be reduced or substantially eliminated by the synchronization of channels C1-C3 (e.g., alignment of the different SOPs), for example, as shown in the TFC of FIG. 4A. That is, since channels C1-C3 have synchronized rotation of their transmission frequencies, collisions may be reduced or substantially eliminated. Reservation made in the beacon period by UWB devices A, B and C may request any length reservation block so long as the reservation block is an integer number of preset periods (e.g., for example, the preset period may be one Media Access Slot (MAS) period).

By providing reservations based on symbol level band multiplexing (i.e., multiplexing in both the time-domain and frequency domain) by simultaneous reservations on different channels, capacity of the communication system may be increased.

FIG. 4C is an exemplary grouping of the UWB devices in accordance with an embodiment of the present invention.

Referring now to FIG. 4C, each UWB device may include (1) a transmitter 490 for transmitting a symbol set in each established transmission frequency bands; (2) a receiver 492 for detecting respective starting times of transmitted symbol sets from the other device for one of the plurality of frequency bands; and (3) a processor 494 for establishing a rotation between or among a plurality of frequency bands, for selecting a starting time of a symbol set based on the detected starting times of symbol sets for the other device, and for controlling the adjustment of the starting time by the transmitter 490 in subsequent transmissions of respective symbols for each of the established transmission frequency bands based on the starting times detected by the receiver 492. The selected starting time may limit interference between symbol sets transmitted by the device and the symbol sets transmitted by the other device to less than a threshold level.

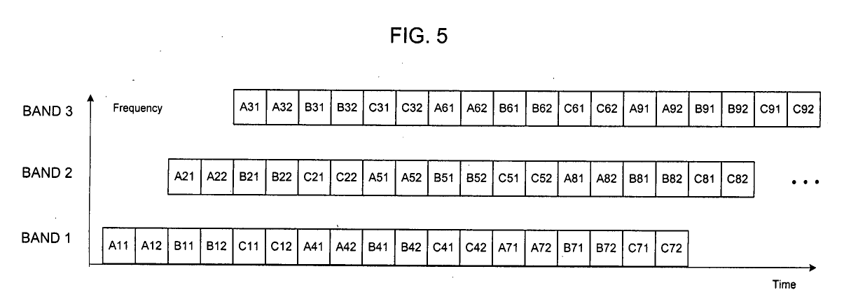

In FIGS. 5, 7, 8, 12, 16A, 16B and 16C, each box represents a symbol, for example, symbol A12 represents a symbol transmitted by UWB device A, as the second successive (consecutive) symbol from symbol set 1 and symbol C91 represents a symbol transmitted by UWB device C, as the first successive (consecutive) symbol from symbol set 9.

FIG. 5 is a timing diagram illustrating an exemplary communication from UWB devices using the TFCs shown in FIG. 4A according to an embodiment of the present invention. By implementing the exemplary TFCs of FIG. 4A and ensuring synchronization of the frames of each UWB device A, B and C in band group 1-4, throughput may be increased and collisions between transmissions may be reduced or substantially eliminated.

Referring now to FIG. 5, UWB device A may transmit sets of symbols (e.g. sets A1-A9) using channel 1 of the TFC of FIG. 4A (i.e., sequencing through frequency bands 1, 2 and 3); and UWB device B may transmit sets of symbols B1-B9 using channel 2 of the TFC of FIG. 4A; and UWB device C may transmit sets of symbols C1-C9 using channel 3 of the TFC of FIG. 4A. In such a case, symbols from a UWB device in a set (i.e., one or more symbols) or from different sets may include redundant content (i.e., repeat information bits to increase reliability of the transmission). That is, symbols may be repeated on the same or a different transmission frequencies (i.e., frequency and/or time-domain spreading): (1) to reduce or substantially eliminate the effect of clock skews of different UWB devices; (2) to increase overall transmission success due to symbols being corrupted from, for example, NBI; (3) to maximize frequency diversity; and (4) to improve performance in the presence of other non-coordinated UWB devices. Such repetition of symbols, however, is not required. Further, symbols may be repeated any number of times.

Although FIG. 5 illustrates symbol sets of two symbols (e.g., A11 and A12, B11 and B12 . . . ), it is contemplated that symbol sets may be any number of symbols (including one symbol). The number may be desirably set to reduce average emissions from each UWB device over a frequency band to below a threshold so that these UWB devices do not interfere with other UWB devices, such as fixed frequency and frequency hopping devices, among others. Further, the number of successive symbol in a symbol set may vary responsive to the condition that timing between UWB devices remains synchronized. That is, if the duration of respective symbol sets from each UWB device (i.e., simultaneously transmitted symbol sets) is the same, their synchronization may be maintained even if the duration of subsequent symbol sets vary in duration.

When UWB devices in the same piconet (i.e., channel of a band group) are arranged to synchronize (e.g., align or coordinate) with other piconets, channel capacity may be increased without collision. If a plurality of UWB devices use a common TFC and each subsequent UWB device starts transmission with an offset of one-symbol set (e.g., a duration equal to a symbol set) or a plurality of symbol sets (e.g., a duration which is an integer multiple of a symbol set), collisions may be reduced or substantially eliminated. For example, in band group 1, within a common coverage area using the TFCs of FIG. 4A, three UWB devices may be multiplexed without collision. That is, the DRP reservations 430 may be allocated based on a symbol set offset (i.e., symbol set level band multiplexing) within channels.

To achieve such a symbol set offset, a unit smaller than a symbol set may be used. Because symbols in time-domain include of a plurality of samples, symbols and/or samples may be used as a basic unit to achieve this symbol set offset. A new Information Element (IE) may be used to achieve this symbol set offset and other timing adjustments.

In other words, to achieve band multiplexing, UWB devices sharing the same reservation block 1a, 2a . . . Na; 1b, 2b . . . Nb; or 1c, 2c . . . Nc may start from different symbols to avoid collision. Starting symbols (e.g., to provide symbol set offset) for each UWB device A, B and C in a band group may be controlled and the symbol set offset may be announced in the BP 410 in addition to the reservation block 1a, 2a . . . Na; 1b, 2b . . . Nb; or 1c, 2c . . . Nc and the channel C1-C3 of the UWB device A, B and C. Symbol set offset may occur only once at the start of DRP reservation 430, and only the first frame 460 in the DRP reservation 430 may be offset. Subsequent frames 460 in DRP reservation 430 follow the established TFC. For example, if the TFC is 3 symbol set periods, offset of UWB devices A, B and C sharing a band group may be set to between 0 to 2 symbol set periods.

DRP reservation 430 may be aligned to reservation block 1a, 2a . . . Na; 1b, 2b . . . Nb; or 1c, 2c . . . Nc. Different UWB devices A, B and C may start from different reservation blocks 1a, 2a . . . Na; 1b, 2b . . . Nb; or 1c, 2c . . . Nc but may be multiplexed in the same band group. To ensure these devices, which share a common reservation block, start with a common symbol set offset, the reservation block may be an integer N number of TFCs in duration.

By synchronizing transmission of frames and providing a rotating time-frequency hopping scheme, the throughput for a SOP can be increased while reducing or substantially eliminating collisions from other SOPs.

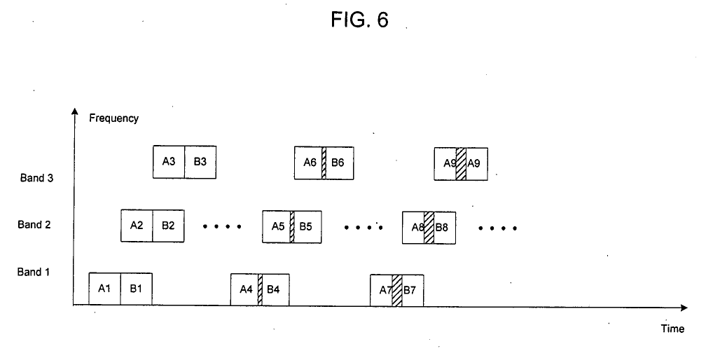

FIG. 6 is a timing chart illustrating collisions between two UWB devices in a multi-band communication system when the UWB devices have slightly unsynchronized clock timing.

Referring now to FIG. 6, A and B represent UWB devices and each block represents a symbol. Cross-hatching denotes collisions between symbols that may produce a corruption (i.e., coincident transmission from the UWB devices on a common frequency band). Although collisions may occur in some of the symbols on some frequency bands, it may be possible to recover these symbols based on, for example, forward error correction techniques.

It is desirable to achieve and maintain timing alignment between UWB devices A and B to reduce or substantially eliminate collisions due to clock skew (i.e., timing misalignment of slightly unsynchronized clock timing). Symbols may be very short in duration (e.g., in the range of less than 1 μs), for example, in OFDM systems that are symbol level band multiplexed. High performance clock hardware may be used to maintain timing alignment between UWB devices A and B. Low performance hardware, e.g., low performance clock hardware, however, is commonly used in consumer electronics to reduce cost. The low performance hardware generates a clock rate that may be skewed. That is, any two UWB devices, for example UWB devices A and B, may have different clock rates. Such clock skews may result in periodic symbol overlap or symbol collisions, as symbols of different devices drift pass.

In FIG. 6 symbols A1 and B1, A2 and B2, and A3 and B3 are respectively aligned without overlap. Symbols A4 and B4, A5 and B5, and A6 and B6 may overlap due to different clock rates used in UWB devices A and B. This overlapping effect is more pronounced (i.e., the overlap becomes greater over time until symbols from UWB device B move past (catch up to those of UWB device A). That is, symbols A7 and B7, A8 and B8 and A9 and B9 overlap more (i.e., have a greater percentage overlap) than symbols A4 and B4, A5 and B5, and A6 and B6, respectively. This overlapping effect due to clock skew causes, for example, collisions between respective symbols, and corruption of these symbols. The corruption may produce a need to retransmit these symbols. The overlapping effect is periodic with symbols moving into and out of collision. Moreover, at times of complete overlap, the Signal to Interference Ratio (SIR) is low and at overlap free times, the SIR is high.

For typical commercial consumer electronic devices, hardware may be used having a maximum clock skews in the range of less than 40 part-per-million (ppm) and desirably less than 20 ppm. If, for example, UWB devices A and B operate with a carrier frequency of 4 GHz and maximum clock skews of 20 ppm, the maximum difference between the clock rates of UWB devices A and B is 0.0040%. In this case, a one-symbol difference may occur in about 1/160 seconds.

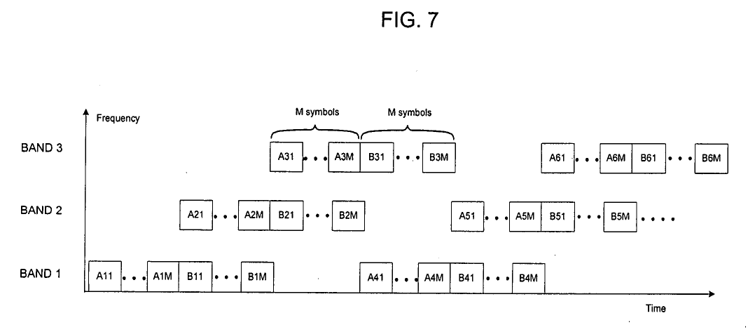

FIG. 7 is a generalized timing diagram illustrating timing of symbols for two UWB devices in a multi-band communication system in accordance with various exemplary embodiments of the present invention when the UWB devices have synchronized clock timing.

Referring now to FIG. 7, UWB device A may transmit M consecutive symbols, for example, as symbol set A1 that includes symbols A11 . . . A1M. In the exemplary embodiment shown in FIG. 7, UWB device A may transmit using frequency band 1 and then switch (adjust) to frequency band 2. UWB device B, synchronized (e.g., aligned) with UWB device A may transmit M consecutive symbols, for example, as symbol sets B1 that includes symbols B11 . . . B1M immediately after UWB device A transmits symbol A1M. In this exemplary embodiment, UWB device B transmits using frequency band 1 and then switches (adjusts) to frequency band 2. That is, band multiplexing is based on a unit of M symbols, as symbol sets. Each of the symbol sets A1-A6 and B1-B6 may include successive (consecutive) symbols (i.e., different symbols) representing successive data (information bits) of a respective communication between UWB devices and/or repeated symbols (i.e., the same symbol) representing repeated data of the respective communication.

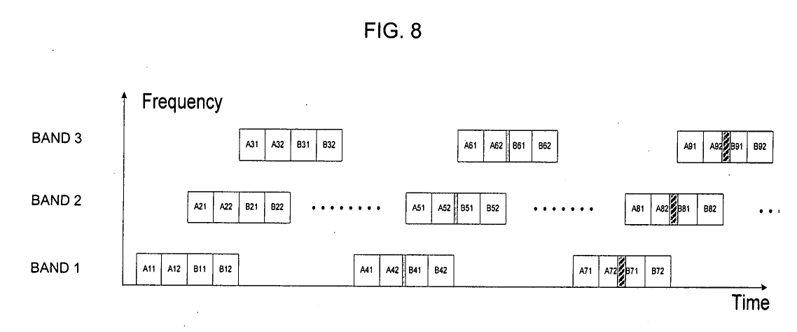

FIG. 8 is a timing diagram illustrating timing of symbols for two UWB devices in a multi-band communication system in accordance with various exemplary embodiments of the present invention when the UWB devices have slightly unsynchronized clock timing.

FIG. 8 illustrates the same frequency hopping scheme (TFC) shown in FIG. 7 with M equal to 2 and slightly unsynchronized clocks, for example, in a range of less than 40 ppm, and desirably less than 20 ppm. UWB devices A and B transmit symbol sets A1-A9 and B1-B9, respectively, on rotating frequency bands 1-3.

Since M symbols of a symbol set may be transmitted in the same frequency band 1-2, 1/M of the total symbols may be corrupted during a specified time corresponding to a certain number of transmitted symbols, as an example 200 symbols to 128*200 symbols for clock hardware having a 20 ppm accuracy. In this case, the overlap rate of symbols in FIG. 8 is 1/m (or 50%) which is a decrease from a 100% overlap rate shown in FIG. 6. Table 1 shows the overlap rate for different values of M for the 200^{th} symbol to the first 128*200 symbols in duration. As M increases, the percentage of affected symbols decreases, however, as M reaches infinity (i.e., UWB devices A and B never switch to another band and assuming each UWB device A and B starts from different frequency bands), emissions may be required to be reduced by 4.7 db to conform with FCC requirements as discussed above.

TABLE 1
Overlap rate for different values of M during first
interval from 200 symbols to 128 * 200 symbols.

| | Overlap rate (%) |
|---|---|
| M | (1-128) * 200 symbols |
| 1 | 100.0 |
| 2 | 50.0 |
| 3 | 33.3 |
| 4 | 25.0 |
| 5 | 20.0 |
| 6 | 16.7 |

That is, after a time lapse corresponding to about 200 symbols, symbols from UWB devices A and B overlap 50.0% of the time. In the system illustrated in FIG. 6, once collisions begin to occur, the collisions affect all symbols, i.e., 100% of the symbols.

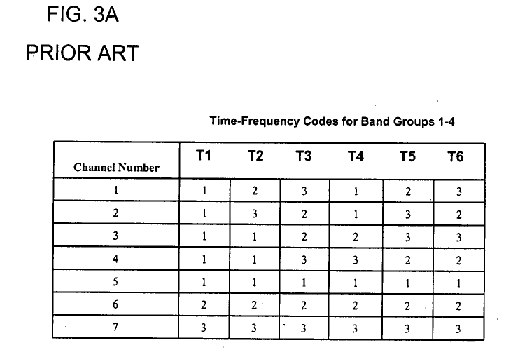

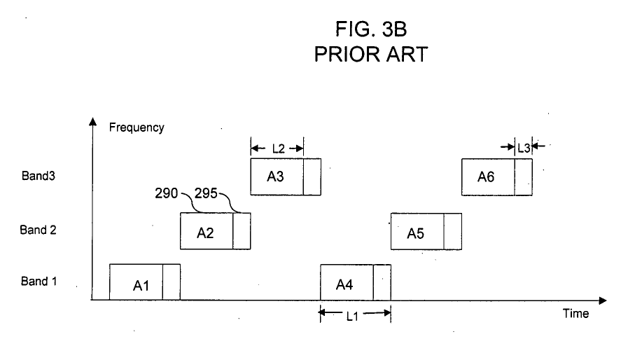

As illustrated in FIG. 3A, for each band group 1-4, band hopping occurs within channels 1-4 between frequency bands 1-3 and repeats periodically. That is, for channels 1-2, the band hopping sequence repeats periodically with a cycle of 3 symbols and for channels 3-4, the band hopping sequence repeats periodically with a cycle of 6 symbols. Moreover, as illustrated in FIG. 4A, band hopping occurs within channels 1-3 between frequency bands 1-3 and repeats periodically (with a cycle of 3 symbols). Because, the band hopping repeat period may be either 3 or 6 symbols in duration, it is desirable to refer to the band hopping repeat period as being 6 symbols.

The basic element for band reuse using symbol set level band multiplexing is the band hopping repeat period or an integer multiple thereof. By establishing MAS and intraframe periods to be equal to the band hopping repeat period or an integer multiple thereof, it is possible for two piconets to maintain synchronization on different frequency bands across MAS or intraframe boundaries under the condition that their initial setting are appropriate.

Conventional UWB systems do not support symbol level band multiplexing. In particular, the duration of the MAS of a conventional system is 819.2 symbols and the duration of intraframe intervals (e.g., SIFS and guard intervals) are also not equal to the band hopping repeat period or integer multiples thereof.

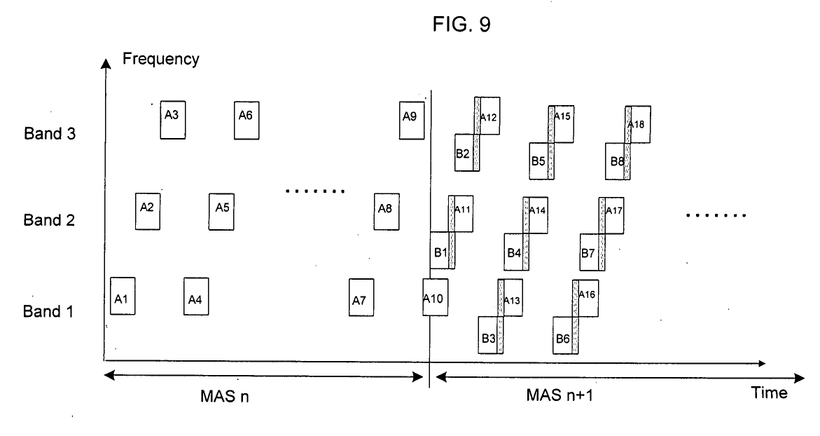

FIG. 9 is a timing chart illustrating the use of conventional MAS periods with UWB devices A and B using channels C1 and C3 of TFC of FIG. 4A to illustrate the problem of misalignment of symbol due to the conventional MAS periods.

Referring now to FIG. 9, UWB device A starts transmitting symbols prior to the start of MAS n and UWB device B starts transmitting at MAS n+1. Symbols transmitted from UWB devices A and B on the same frequency band are shown above one another. Shaded areas of symbols represent collisions between symbols transmitted by UWB devices A and B. Due to the duration of the MAS (i.e., 819.2 symbols), symbols from UWB device B are retarded relative to those of UWB device A by 0.2 symbol periods in MAS n+1. Because of this misalignment, for each frequency band 1, 2 and 3, the beginning of symbols A11-A18 of UWB device A collide with the end of symbols B1-B8 of UWB device B, respectively. Such collisions, however, may cause corruption of each corresponding symbol and may necessitate retransmission of these symbols.

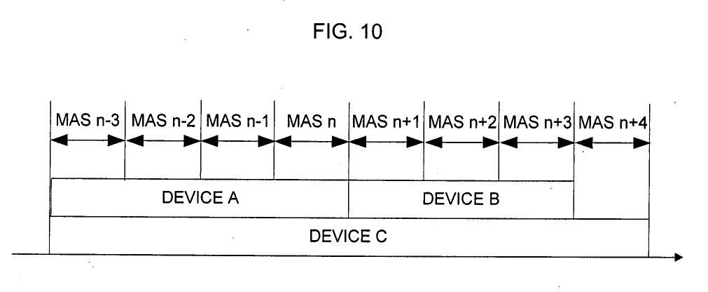

FIG. 10 is a timing diagram illustrating MAS periods that are set to a frequency hopping repeat period or an integer multiple thereof to enable synchronization (alignment) of symbols within a super frame (i.e., across MAS boundaries).

Referring now to FIG. 10, UWB devices A, B and C may reserve DRP 430, for example in units of MAS such that UWB device A reserves MAS blocks n−3 to n, UWB, device B reserves MAS blocks n+1 to n+4 and UWB device C reserves MAS blocks n−3 to n+3. In this case, if the MAS period is set equal to the frequency hopping repeat period or an integer multiple thereof, then synchronization across MAS block boundaries may be realized. That is, for example, if UWB devices A, B and C are on different piconets operating in a common coverage area and using a common band group, UWB devices A and C may be aligned (i.e., their transmitted symbols may be symbol set level band multiplexed) and UWB devices B and C may also be aligned. Further, the transmitted symbols of UWB device B may begin transmission just after those of UWB device A end transmission.

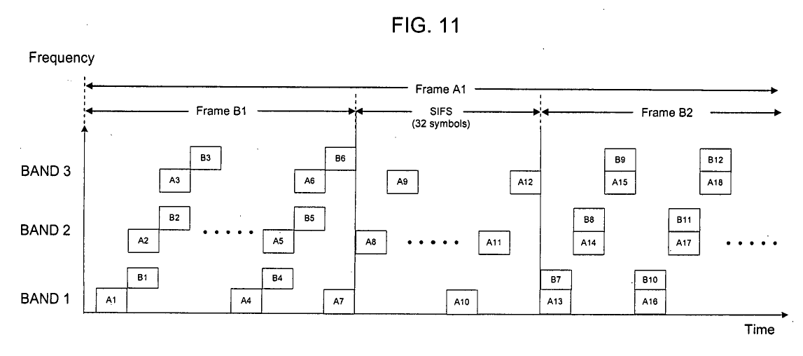

FIG. 11 is a timing chart illustrating the use of a conventional intraframe period 270 with UWB devices A and B using channels C1 of the TFC of FIG. 4A, with a one symbol offset for UWB device B relative to UWB device A to illustrate the problem of misalignment of symbols due to this conventional intraframe period. Conventionally, intraframe periods 270 and 280 are fixed duration periods, for example, typically, the SIFS period is 10 μs (i.e., 32 symbols in duration), and the Guard period is 12 μS (i.e., 38.4 symbols in duration).

Referring now to FIG. 11, UWB device A transmits in a frame A1 (i.e., a single frame) while UWB device B transmits in frames B1 and B2 with a gap of SIFS, 32 symbols in duration, in between frames B1 and B2. Symbols transmitted from UWB devices A and B on the same frequency band are shown above one another. In FIG. 11, UWB device B may start transmitting using one frequency band, for example frequency band 1 with a one symbol set offset relative to the transmission from UWB device A, rotate transmission frequencies corresponding to channel C1 in frame B1 and have an SIFS gap (i.e., an intraframe period of 32 symbols). The next transmission in frame B1 may start again on frequency band 1 (because the previous transmission, which is the last transmission in frame B1, had been from frequency band 3) and rotate transmission frequencies according to channel C1 of the TFC of FIG. 4A. That is, UWB device B may start transmission on a common frequency band 1 in a subsequent frame (i.e., the next frame).

Simultaneous with frames B1 and B2 and the intraframe period, UWB device A may transmit on the same channel C1 without any symbol offset. Because of the duration of the SIFS (i.e., 32 symbols), as illustrated in FIG. 11, collisions occurs between symbols A13-A18 and B7-B12, respectively. Such collisions may cause corruption of each symbol and may necessitate retransmission of these symbols.

Although a SIFS intraframe period of 32 symbols is illustrated to show misalignment in the next frame B2, it is understood by one of skill in the art that other intervals that are not the frequency hopping repeat period or and integer multiple thereof produce a similar misalignment of any subsequent frame (i.e. frame B2) after the intraframe period. In particular, the conventional guard interval produces such a misalignment.

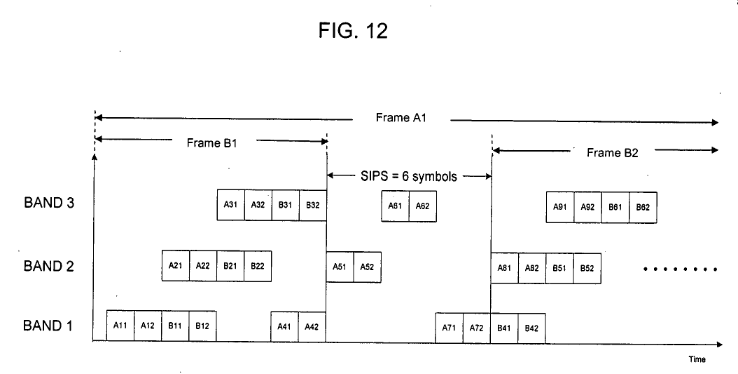

FIG. 12 is a timing chart illustrating symbol alignment for symbol set of two symbols (i.e., when M=2) when the intraframe period is 6 symbols (i.e., equal to the frequency hopping repeat period.

Referring now to FIG. 12, UWB device A may transmit in frame A1 (i.e., a single frame) while UWB device B may transmit in frames B1 and B2 with a gap of SIPS, 6 symbols in duration, in between frames B1 and B2. UWB device B may start transmitting in frame B1 using one frequency band, for example, frequency band 1, may rotate transmission frequencies corresponding to, for example, channel C1 of the TFC shown in FIG. 4A (i.e., with a two symbol offset relative to symbols from UWB device A) and may have a SIPS gap (i.e., an intraframe period of 6 symbols). The next transmission in frame B2 for UWB device B may start again on frequency band 1 (because its previous transmission had been on frequency band 3) and rotate transmission frequencies. That is, UWB device B may start on a common frequency band 1 in a subsequent frame (i.e., the next frame). For the case of M=2, UWB devices may start from the same (common) frequency band 1 in future frames. Simultaneous with frames B1 and B2 and the SIPS intraframe period, UWB device A, may transmit on channel C1 with no symbol offset. Because of the duration of the SIPS (i.e., 6 symbols) the relative offset between symbols from UWB devices A and B are maintained across intraframe SIPS. That is, because the SIPS is 6 symbols in duration which is equal to the frequency hopping repeat period, alignment across the SIPS intraframe period may be maintained for devices A and B.

Intra-frame periods, such as intra-frame intervals 470 and 480 shown in FIG. 4B and MAS periods desirably may be set to the frequency hopping repeat period or any integer multiple thereof. Intraframe periods may be selected to be, for example, 6 symbols. In such a case, to maintain symbol alignment for 3 frequency bands, M may be 2 symbols in duration.

It is understood by one skilled in the art that for similar reasons to those described above, the Priority Channel Access Period and Beacon Period (BP) desirably may be a duration equal to the frequency hopping repeat period or any integer multiple thereof.

A large portion of the time, for example, a system of two UWB devices may work in a collision state. Collision may be treated as equivalent to noise that reduces a signal-to-noise ratio (SNR) and degrades performance. Certain embodiments of the present invention may reduce the percentage of corrupted symbols, and/or may reduce the average number of corrupted symbols to improve performance in terms of SNR, for example, by timing adjustments to clock rates to improve synchronization of UWB devices with clock skews.

FFT spreads sample corruption in the time domain to all sub-carriers. Because some sub-carriers are reserved as pilot tones, for example, in a Multi-Band (MB) OFDM system, the pilot tones may be corrupted. The pilot tones may be used to detect collisions, however, such detection may only occur in the frequency domain. When continued quality degradation is detected for these pilot tones, a determination may be made that collisions are occurring. For the MB-OFDM system shown in FIG. 6, as an example, it is difficult or impossible to distinguish which of the samples in the time domain may be corrupted (e.g., in which direction collisions start). In various embodiments of the present invention, for example as illustrated in FIG. 8, the place where collisions start may be determined in terms of symbols (at the sample or symbol level). For example as shown in FIG. 8, a collision starts from a second symbol of symbol set A4 (i.e., A42), i.e., collision on the second symbol in frequency band 1 for UWB device A and a first symbol of symbol set B4 (i.e., B41) in frequency band 1 for UWB device B. Signal quality of these two symbols A42 and B41 for common frequency band 1 may be different than other symbols on the same frequency band 1 when the collision occurs. Moreover, the signal quality of these two symbols A42 and B41 for common frequency band 1 may be different when collisions are occurring relative to when collisions are not occurring. That is, symbols, for example A42, A52, A62, A72, A82, A92, B41, B51, B61, B71, B81 and B91 that are subject to collision may exhibit lower signal quality than other symbols that are not in collision. If the first symbol experiences a lower signal quality than other symbols, a collision may be indicated for the first symbol and otherwise, the collision may be indicated for a last symbol in a symbol set. For M=2 the last symbol in the symbol set is the second symbol in the symbol set as shown in FIG. 8.

Determining which symbols are colliding allows timing adjustments to be performed in any number of ways. For example, the timing of one of the two UWB devices A and B in collision may be adjusted (e.g., the timing of the slower clock rate device may be increased to synchronize its timing to that of the faster clock rate device or, desirably the timing of the faster clock rate device may be decreased to synchronize its timing to that of the slower clock rate device). Moreover, the actual amount of the timing adjustment desirably may be equal to at least the duration of the number of corrupted consecutive symbols of a symbol set for the UWB device having its timing adjusted. Other timing adjustments are also contemplated which may adjust clock synchronization differences.

It is contemplated that either one or both of the timings of UWB devices A and B may be adjusted so long as the adjustment tends to bring the synchronization of these UWB devices back into alignment, since the system is then self correcting over a plurality of transmissions. With such timing adjustments, it is contemplated that timing differences may be limited to one symbol or less in duration such that corrupted symbols of a symbol set having M consecutive symbols may be limited to a ratio at or below 1/M.

It is further contemplated that, if collisions occur that affect more than one symbol of a symbol set, the timing adjustment may be more than one symbol and may be, for example, substantially proportional to or correspond to the duration of the corrupted symbols and/or samples of the symbol set. That is, if N symbols of UWB devices A are subjected to collision by N symbols of UWB devices B where N is less than M, UWB devices A and B may detect degradation in the demodulation of either or both of these N symbols of UWB devices A and B. If UWB device B has a faster clock rate than that of UWB device A, the N symbols are at the beginning of each symbol set for UWB device B and at the end of each symbol set for UWB device A, and UWB device B may retard its transmission by at least N+1 symbols to prevent further collisions. If UWB device A has a faster clock rate than UWB device B, the N symbols are at the beginning of each symbol set for UWB device A and at the end of each symbol set for UWB device B and UWB device A may retard its transmission by at least N+1 symbols to prevent further collisions. To prevent collision for a certain time, (related to, for example, intra-frame periods) transmission may be retarded by more symbols than N+1 symbols.

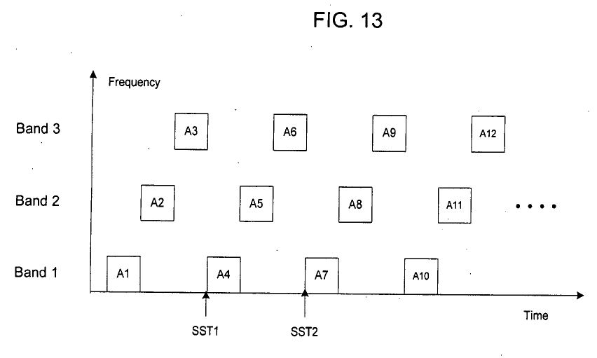

FIG. 13 is a timing chart illustrating frequency hopping repeat periods and symbol starting times relative to each frequency hopping repeat period.

Referring now to FIG. 13, UWB device A may transmit symbols A1-A12 using channel C1 of the TFC of FIG. 4A. The transmitted symbols may be regarded as a series of band hopping sequences. That is, the starting time of each transmitted symbol of a particular frequency band (in this case frequency band 1) may be denoted as Symbol Start Time (SST) with the first occurrence on the particular frequency band being SST1 and subsequent occurrences being SST2 . . . SSTn. Because the band hopping pattern repeats (i.e., is periodic) after three symbols, SST1 and SST2 are the same SST relative to the frequency hopping repeating pattern. Thus, the starting times may be measured relative to the band hopping repeat pattern (i.e., within the 3 symbol duration representing the repeat period). In general, for any TFC which repeats the usage of frequency bands after N symbols in a periodic manner, the SST may be described relative to the timing of the N symbols (i.e., one repeat period). If N=3 for symbol sets equal to one symbol, as shown in FIG. 13, the SST may be described within any interval shown in Equation 1 as follows:
0≦SST≦3L_{symbol} (1)
where L_{symbol} is the length of one symbol.

By specifying a SST, a Signal to Interference Ratio (SIR) may be measured at receivers of UWB devices. One skilled in the art understands that the starting time for a measurement of the SIR level may affect the SIR level measured. In other words, the instantaneous SIR level varies within a repeat period.

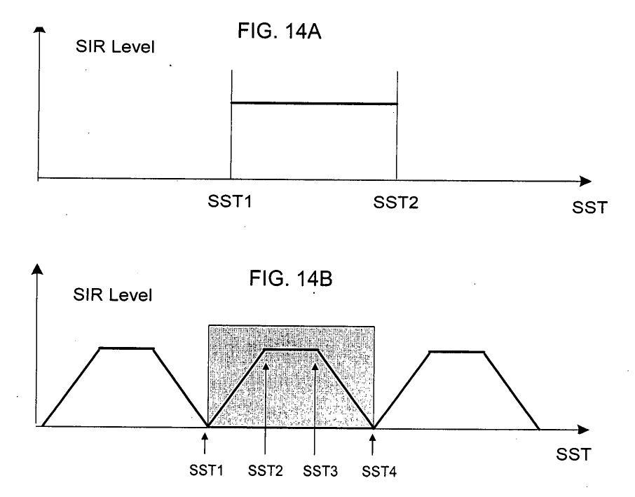

FIGS. 14A and 14B are graphs illustrating the relationship between SIR level and SST for 2 different situations. In particular, FIG. 14A shows SIR level vs. SST when one piconet, i.e., piconet A, is operating in a coverage area with no other piconets in the vicinity; and FIG. 14B shows SIR level vs. SST when two piconets, i.e., piconets A and B are operating in a common coverage area using a common frequency band group.

Referring now to FIG. 14A, if piconet A operates in a coverage area without any other piconets nearby (e.g., in or around the coverage area), UWB devices of piconet A do not experience any co-channel interference, because all of the UWB devices in piconet A are synchronized. Thus, respective UWB devices using piconet A, in general, have about the same SIR level at different SSTs. Because the SST is relative to the frequency hopping repeat period which has in this case a 3 symbol repeat period, the SIR level beyond SST1 and SST2 may be extrapolated according to the repeat period. That is, SIR level may be described by Equation 2 as follows:
SIRₗ=SIRₗ₋₁+3L_{symbol} (2)

Referring now to FIGS. 14B, if piconet A operates in a coverage area with piconet B nearby (i.e., in or around the coverage area), UWB devices of piconet A may encounter co-channel interference, because these UWB devices are not synchronized with UWB devices of piconet B.

That is, symbols for two piconets A and B that operate on one channel are not synchronized. As a result, when symbols from UWB devices of piconet A are advanced or retarded over time with respect to corresponding symbols from UWB devices of piconet B (e.g., due to clock skew), these symbols at a particular point in time move into an overlap condition. At the point of complete overlap of a symbol from one UWB device of piconet A with a symbol from another UWB device of piconet B, co-channel interference tends to peak and the SIR level decreases to a minimum. That is, for a particular frequency band when a symbol of UWB device A on piconet A that is drifting (moving) past a symbol of UWB device B, completely overlaps with the symbol of UWB device B, the SIR level is minimized, as indicated at point SST1. Moreover, as these symbols move out of collision, the SIR level increases to a maximum at point SST2 corresponding to no collision between these symbols. Because the frequency hopping repeat period is 3 symbols in duration and the symbol set length is one symbol, this collision free state (i.e., maximum SIR level) is maintained for 1 symbol length. After point SST3, the collision free state ends and the transmitted symbols again begin to collide with an increasing portion of these symbols moving back into collision. At point SST4 the symbols are again completely overlapped and the SIR level again reaches a minimum level corresponding to the complete overlap of these symbols of UWB devices A and B. Although lines are used to illustrate the transition of the SIR from a maximum level (i.e. peak level) to a minimum level and from the minimum level to the maximum level, these lines are only for illustration purposes. Actually, the SIR level may not change in a linear pattern while transitioning between the minimum and maximum levels.

Thus, respective UWB devices using piconet A, as an example, have a SIR level that is periodic and that varies within each frequency hopping repeat period. Because the SST is relative to the frequency hopping repeat period which in this case is 3 symbols in duration and is represented by the shaded area of FIG. 14B, SIR level beyond the SST1 and SST2 may be extrapolated according to one frequency hopping repeat period. The SIR level pattern repeats beyond the points SST1 and SST4 as illustrated in FIG. 14B and SST1 is equivalent to SST4 relative to the frequency hopping repeat period.

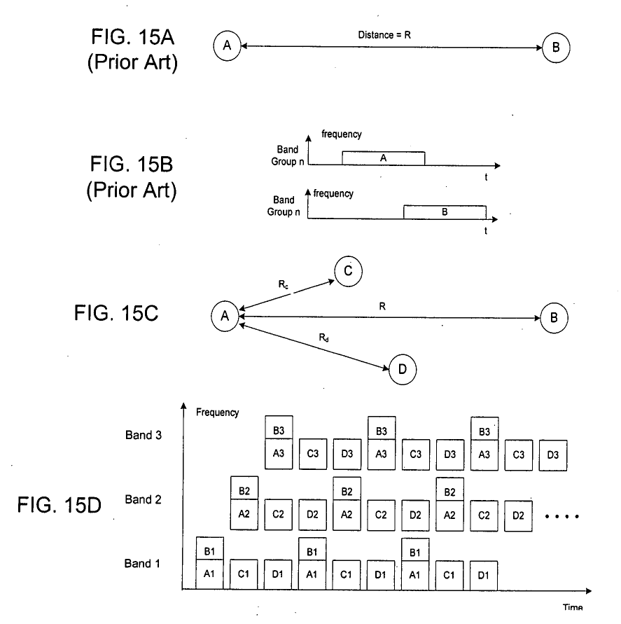

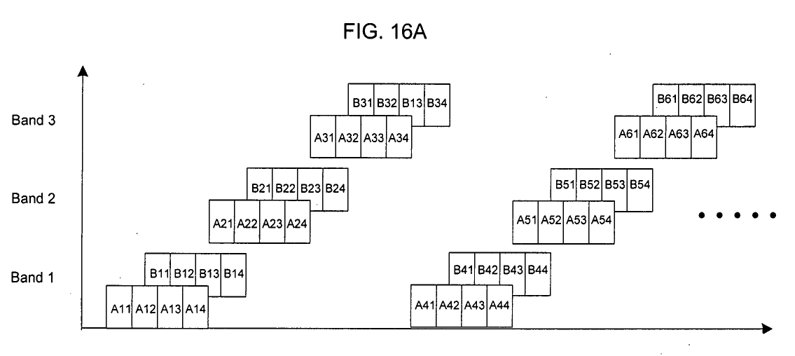

FIGS. 15A and 15B are schematic diagrams illustrating band reuse with a conventional SIR-based UWB communication system.

Referring now to FIGS. 15A and 15B, piconets A and B operate using a common band group (e.g., selected from band groups 1-4) in respective coverage areas and are a distance of R from each other. The transmissions from their UWB devices overlap in the time domain as illustrated in FIG. 15B. Because piconets A and B use the same frequency bands, the distance R, conventionally, is made large enough to reduce co-channel interference between the UWB devices of piconet A and B to below a threshold level for proper operation of these piconets.

FIG. 15C is schematic diagram illustrating a band reuse method for a UWB communication system according to yet another exemplary embodiment of the present invention. FIG. 15D is a timing chart illustrating the operation of the communication system of FIG. 15C.

Referring now to FIGS. 15C and 15D, piconets A and B operate using a common band group (e.g., selected from band groups 1-4) in respective coverage areas and are a distance of R from each other. The transmissions from their UWB devices overlap in the time and frequency domains as represented by for example symbols B1 over A1 for frequency band 1. Two other piconets C and D operate in their own coverage areas at distances to piconet A of R_{c} and R_{d} respectively. If R_{c} and R_{d} are both equal to or less than R, then piconets C and D fall inside a circle with center at picohet A and radius of R. In the conventional SIR-based UWB communication system of FIGS. 15A and 15B, co-channel interference from UWB devices of piconets C and D may be greater than the established threshold level and may jeopardize proper operation of UWB devices of piconet A (i.e., because their distance to piconet A is less than the minimum required to retain the minimum SIR level for normal operation of the UWB devices of piconet A). Also, if the distance between piconets C and D is less than R, they themselves may interfere with each other and if their distances to piconet B are less than R, piconet B may also be affected by interference from one or both of piconets C and D.

Because piconets A and B use the same frequency bands, the distance R is large enough to reduce co-channel interference between them to below the threshold level for proper operation of these piconets.

As shown in FIG. 15D, if symbol set level band multiplexing is used with band reuse, piconets A, B, C and D illustrated in FIG. 15C do not interfere with each another.

Referring now to FIG. 15D, piconets A, B, C, and D each include at least one UWB device A, B, C and D, respectively. Each of these UWB devices may operate in a common band group 1-4 using the TFC of FIG. 4A. More particularly, (1) at least one UWB device A of piconet A and at least one UWB device B of piconet B may use channel C1 of the TFC of FIG. 4A, (2) at least one UWB device C may use channel C2 of the TFC of FIG. 4A and (3) at least one UWB device D may use channel C3 of the TFC of FIG. 4A. Because channels C1, C2 and C3 are synchronized within each band group (e.g., piconets A, B, C and D are aligned based on information from their respective beacon periods), there may be negligible or no interference between or among: (1) UWB devices A, C and D or (2) UWB devices B, C and D. Moreover, because A and B are a distance of R apart (i.e., the minimum conventional distance for the SIR level to be below the threshold level), UWB device D may reuse the assigned channel of UWB device A (i.e., channel C1) with negligible co-channel interference, thereby allowing proper operation of piconets A, B, C and D as shown in FIG. 15C. The capacity of each band group using this SIR-based band reuse method and symbol set level band multiplexing is increased over that using a conventional SIR band reuse scheme.

According to certain exemplary embodiments, by scanning for the existence of other piconets when a piconet starts operation (e.g., when a first UWB device of the piconet beings operation), the piconet (UWB device) may select to transmit using a particular band group and SST according to the result of the scan. Scan result may be categorized into three different types: (1) no other piconet nearby; (2) one or more piconets are close enough to allow correct demodulation; and (3) one or more piconets are detectable but are not close enough for demodulation. That is, the first UWB device of a piconet to commence operations may scan at least one entire superframe to locate other UWB devices on other piconets. After scanning for other UWB devices, if the first UWB device cannot detect any other UWB devices (i.e., no other piconets are nearby), the UWB device (piconet) may use any band group and may starts transmission at anytime or set its SST at any time instant.

After scanning for other UWB devices, if the first UWB device detects one or more UWB devices of one or more other piconets that are close enough to allow correct demodulation and/or if it detects strong periodic preambles, the piconet may determine the SSTs of each existing piconet on the particular frequency band scanned.

Pn and SSTn refer to a new piconet and its symbol start time. Moreover, for brevity, each piconet unless otherwise noted uses a common band group, a common TFC.

If the number of piconets found (i.e., detected) in the scan is L and each has a different SST (i.e., SST₁, SST₂ . . . SST_{L}) and if L is less than or equal to N, where N is the number of frequency bands in a particular band group, it is possible that a new piconet Pn may be added to the band group depending on the relative positions of the starting times SST₁, SST₂ . . . SST_{L} of the existing piconets P1, P2 . . . PL, respectively, currently using the common band group.

For the case of N=3 (i.e., 3 frequency bands) as shown in the TFC of FIG. 4A and M=1 (i.e., one symbol per symbol set), L may equal 0, 1 or 2. If L=0, then no other piconets have been found and the new piconet may select its SSTn to be at any time in the band hopping repeat period. If L=1, a new piconet Pn may use the common band group under the condition that the SSTn is selected to satisfy the inequality 3 as follows:
1≦|SSTₙ−SST_{L}|≦2 (3)

That is, if one other piconet is detected, and its SST is determined to be SST_{L}, then the new piconet may commence transmission at SSTn such that its start time is in an interval defined by the inequality 3. The interval may be defined by one symbol duration starting at or after the SST_{L} of a first frequency hopping repeat period of the detected piconet and ending one symbol duration at of before the SST_{L} of a subsequent frequency hopping repeat period (see FIG. 13 regarding SST1 and SST2).

If the SSTn is selected under the condition as follows:
|SSTₙ−SST_{L}″=1 or |SSTₙ−SST_{L}|=2
further band multiplexing still may be permitted. That is, an unused time slot of each frequency band is large enough in duration to accommodate another piconet without collision between UWB devices. If the SSTₙ is selected in any other range permitted by the inequality 3, further band multiplexing may not be allowed because the unused time slot or time slots in the frequency band are not large enough in duration to accommodate another piconet without collision between UWB devices.

If L=2, a new piconet Pn may use the common band group under the condition that:
|SST₂−SST₁|=1 or |SST₂−SST₁|=2
That is, if piconets A and B are detected such that piconet A has a SST of SST₁ and piconet B has a SST of SST₂ which follow the above equation then the new piconet may still be permitted to commence operation in this band group if its SST is selected under the conditions of the inequality 3 and further as follows:
|SSTₙ−SST_{L}|=1 or |SSTₙ−SST_{L}|=2
and SSTₙ≠SST₁ and SSTₙ≠SST₂

That is, when the number of piconets sharing a common band group equals the number of frequency bands in the common band group, each piconet sharing the common band group has a common spacing of starting times. If M=1, the spacing may be exactly one symbol, if M=2, the spacing may be exactly two symbols and if M=K, where K is an integer, the spacing may be exactly K symbols.

When N=3 (i.e., the number of frequency bands in a band group is 3) and L=2 (i.e., the number of detected piconets in a common band group is 2), if a new piconet is then added to the common band group, the band group is full such that additional piconets that are added to the band group desirably may be at least a minimum contact distance R from at least one of the existing three piconets, as illustrated in FIGS. 15C and 15D.

Although, equations for the case of N=3 and M=1 are set forth above for the addition of a new piconet Pn to a common band group having L existing piconets, it is understood by one of skill in the art that these equation may be extrapolated for any N (i.e. number of frequency bands in the band group) and M (number of symbols in a symbol set).

Although frequency band reuse using band multiplexing has been shown using a band group of 3 frequency bands, it is contemplated that such a reuse scheme may be used with a band group containing any number of frequency bands and permits at least an equal number of piconets to operate simultaneously and possible more depending on whether one or more of the piconets are at least the minimum contact distance R from one or more other existing piconets.

If the new piconet Pn cannot be added to the particular band group (e.g., further band multiplexing of UWB devices of the new piconet Pn in the band group is not possible), the new piconet Pn may select a different band group from which to commence operations (i.e., communications).

In the case where multiple piconets are operating on the same band group and at a common SST, it may not be possible to detect them because detection of piconets that are interfering with each other may not be possible.

A new piconet Pn may detect one of more other piconets in at least three different ways. First, if the symbols from a UWB device on another piconet can be demodulated, the SST may be derived from the start times of the symbols from the UWB device. Next, if the strength of the signal received (e.g., based on its SNR) is below a threshold level, the symbols may not be able to be demodulated. In this case, the new piconet Pn may detect a strong periodic signal corresponding to a preamble of the UWB device from another piconet. Based on a presumed fixed length of the periodic preamble, the SST of the detected piconet can be determined. Last, if a device on the new piconet Pn cannot demodulate symbols due to low signal to noise levels and cannot detect a strong periodic preamble, the UWB device (and the new piconet Pn) may use the particular band group and may test with different SSTns to find a SSTn that achieves the “best” (i.e., optimum) SIR level. In certain exemplary embodiments the SSTn may be selected based on scanning for a large enough time slot for a frequency band that corresponds to the largest composite SIR level scanned. In other exemplary embodiments, the SSTn may be selected based on scanning for a large enough time slot for the frequency band having the flattest SIR level scanned, thus, indicating no piconets nearby using this time slot. Due to the periodical characteristics of the SST, the SSTn can be set as follows for efficient detection:
0≦SSTₙ<3L_{symbol} (4)
where L_{symbol} is the length of one symbol.

After a device on the new piconet Pn scans for other piconets, if the other piconets are detected but are not close enough for demodulation, the new piconet may transmit a test sequence to determine the SSTs of any piconets nearby (i.e., that may interfere with the operation of the new piconet Pn).

As illustrated in FIG. 8, when the symbol set is at least M=2 or greater, the place where collision starts may be determined in terms of symbols. That is, a collision starts from one symbol, i.e., collision on a first symbol in one frequency band for UWB device A and a second symbol in the same frequency band for UWB device B. Signal quality of the two symbols on the same frequency band is different during a collision. The symbol or symbols experiencing collision exhibit a lower SIR level than other symbols which are not affected by such collisions. In a symbol set with M=2, if the first symbol experiences a lower SIR level, it may indicate that a collision occurred with the first symbol. Otherwise, if the SIR level is lower than expected, a collision may have occurred on the second symbol (i.e., the last symbol of the symbol set).

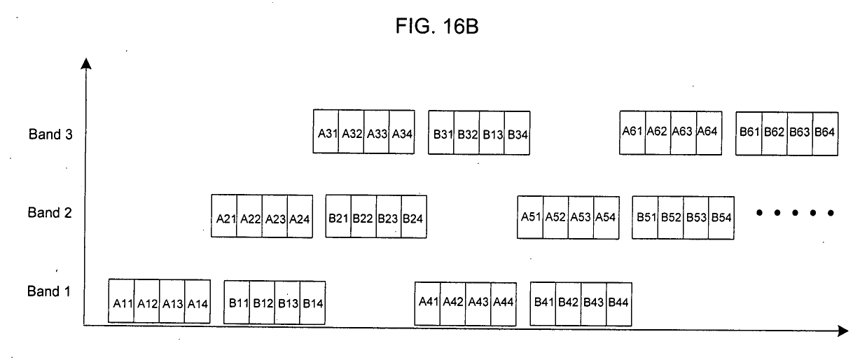

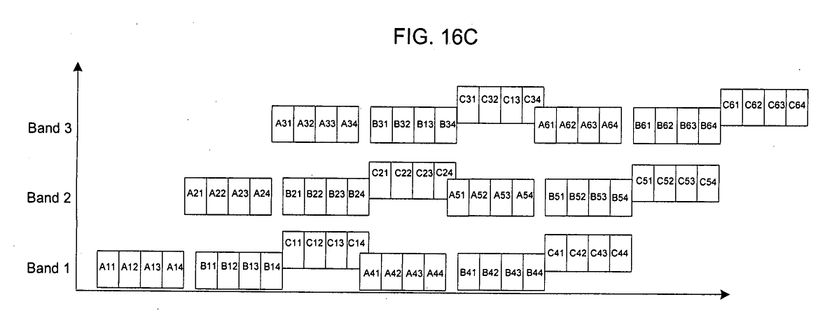

FIGS. 16A-16B are timing charts illustrating SST adjustments to align symbols from UWB devices A and B of two different piconets according to yet another embodiment of the present invention.

Referring now to FIG. 16A, for example, by analyzing a received test sequence, the SIR level of each symbol in a symbol set of M symbols may be detected. These SIR levels correspond to the respective symbols and may reveal information regarding the direction and the number of symbols for SST adjustment. If a collision occurs in the first L symbols of the symbol set, the SST may be retarded by L symbols. If the collision occurs, however, in the last L symbols of the symbol set, SST may be advanced by L symbols. Such an adjustment of the SST may enable substantial alignment (a coarse alignment) of two piconets to a range of about one symbol (i.e., ±1 symbol).

As shown in FIG. 16A, UWB devices A and B from piconets A and B, respectively, may transmit using a common band group of frequency bands 1, 2 and 3. More particularly, UWB device B may have an initial SST such that M=4 and L=3. That is, the symbol set may be 4 symbols in length and the first 3 symbols of UWB device B may be in collision with symbols of UWB device A. The SIR level corresponding to these symbols in collision may be lower than other symbols in the same symbol set that are not in collision.

After a determination that the first 3 symbols of UWB device B are in collision, a SST of UWB device B may be retarded by 3 symbols as shown in FIG. 16B. If, for example, a partial overlap occurs between the last symbols A14, A24, A34, A44, A54 and A64 of UWB device A and the third symbols B13, B23, B33, B43, B53 and B63 of UWB device B, respectively, as shown in FIG. 16A, after the SST adjustment a gap may occur as shown in FIG. 16B.

The above SST adjustment operation estimates the SST to the range of about one symbol, and may leave a small gap of less than one symbol between the symbols of UWB devices on piconets A and B. This gap may not affect the operation of piconets A or B, but may prevent further band multiplexing. That is, a further piconet may not be able to be added to the band group due to collisions.

FIG. 16C is a timing chart illustrating the insertion of a UWB device C from a third piconet C to piconets A and B of FIG. 16B in which UWB device C may cause collisions to UWB devices of either A or B or possibly both A and B.

Referring now to FIG. 16C, UWB device C of piconet C may be added to (i.e., inserted into a time slot of) the common band group of piconets A and B. If the SST of UWB device C (and piconet C) is selected to be just after the last symbol, for example B14, in the symbol set 1 of UWB device B (and piconet B) as shown in FIG. 16C, the last symbol C14 of the symbol set 1 of UWB device C may overlap with the first symbol A41 of symbol set 4 of UWB device A.

Although an overlap of piconet C with piconet A is shown, it is contemplated that other overlaps are possible including an overlap of piconet C with piconet B or an overlap of piconet C with both piconets A and B. This is because the gap between piconets A and B does not allow (e.g., is not large enough in duration to allow) piconet C to be inserted without at least some overlap.

To further reduce or eliminate gaps or overlaps, piconet B may transmit test sequences at different SST locations to find its best SST position, i.e., when
|SST_{A}−SST_{B}|=1 or |SST_{A}−SST_{B}|=2

That is, for example, UWB device B on piconet B may send out dummy symbols at various times and determine whether the received signal at these times have experienced collisions with UWB device on piconets A or C. By sending such test sequences, UWB device B may determine the boundaries (beginning or end) of the symbol set for UWB device A of piconet A and may adjust its SST accordingly for fine adjustment of its SST (and thus the SST of piconet B). After piconet B adjusts its SST, UWB device C of piconet C may perform a similar process and, thus, eliminate the overlap of symbols, for example, the last symbol C14 of the symbol set 1 of UWB device C with the first symbol A41 of symbol set 4 of UWB device A. Thus, test sequences may be used for fine SST adjustment of less than one symbol.

Although test sequences have been described for fine adjustment of the SST of a piconet relative to one or more other piconets, it is contemplated that the test sequence may be used for coarse adjustments and, otherwise, that other adjustment operations are possible. For example, instead of transmitting test symbols, devices on the piconet may remain silent during test intervals and detect any transmission from other UWB devices from any other piconet directly to determine the SST or ending times of the other piconet (i.e., the boundaries of a symbol set).

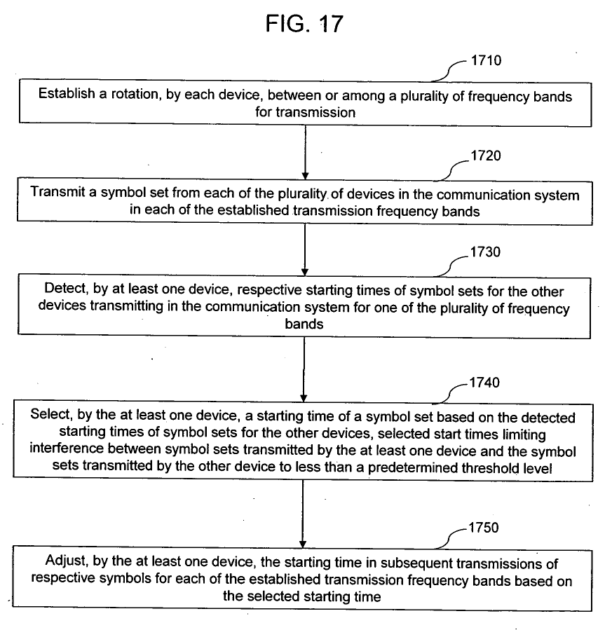

FIG. 17 is a flow chart illustrating a control method of band multiplexing communication in accordance with yet another embodiment of the present invention.

Referring now to FIG. 17, at block 1710, a rotation may be established between or among a plurality of frequency bands for transmission by each of the UWB devices on a multi-band communication system. At block 1720, a symbol set of one or more symbols may be transmitted from each of the plurality of UWB devices in the communication system at each of the established transmission frequency bands. At block 1730, respective starting times of the symbol sets may be detected by at least one UWB device for the other UWB devices transmitting in the communication system for one of the plurality of frequency bands.

At block 1740, a starting time of a symbol set may be selected, by the at least one UWB device, based on the detected starting times of symbol sets for the other UWB devices. The selected start times enables interference between symbol sets transmitted by the at least one UWB device and the symbol sets transmitted by the other UWB device to be reduced or substantially eliminated. At block 1750, the starting time in subsequent transmissions of respective symbols for each of the established transmission frequency bands may be adjusted by the at least one UWB device based on the selected starting time.

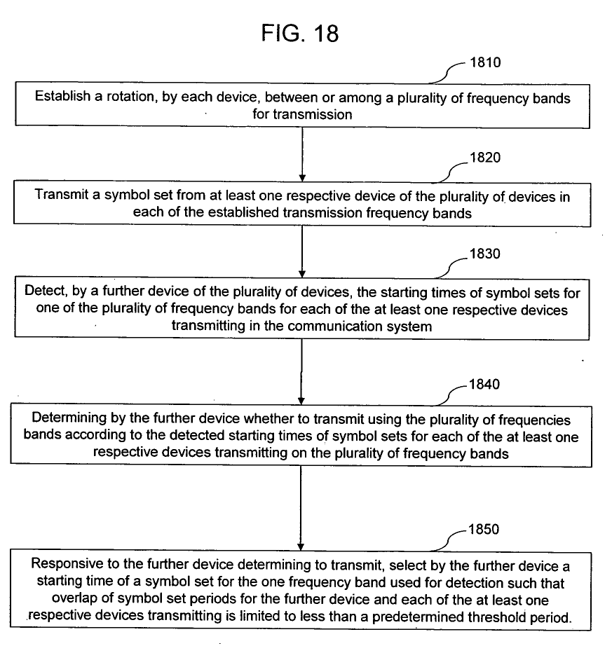

FIG. 18 is a flow chart illustrating a control method of band multiplexing communication in accordance with yet another embodiment of the present invention.

Referring now to FIG. 18, at block 1810, a rotation may be established between or among a plurality of frequency bands for transmission by each of the UWB devices on a multi-band communication system. At block 1820, a symbol set may be transmitted from at least one respective UWB device of the plurality of UWB devices in the communication system at each of the established transmission frequency bands. At block 1830, the starting times of symbol sets for one of the plurality of frequency bands for each of the respective UWB devices transmitting in the communication system may be detected by a further UWB device of the plurality of UWB devices.

At block 1840, the further UWB device may determine whether to transmit using the plurality of frequencies bands according to the detected starting times of symbol sets for each of the respective UWB devices transmitting on the plurality of frequency bands. At block 1850, responsive to the further UWB device transmitting, a starting time of a symbol set for the one frequency band used for detection is selected by the further UWB device such that overlap of symbol set periods for the further UWB device and each of the respective UWB devices that are currently transmitting is limited to less than a predetermined threshold, for example, the predetermined threshold may be any duration less than the band hopping repeat period, and, desirably in a range of about one sample to about one symbol in duration.

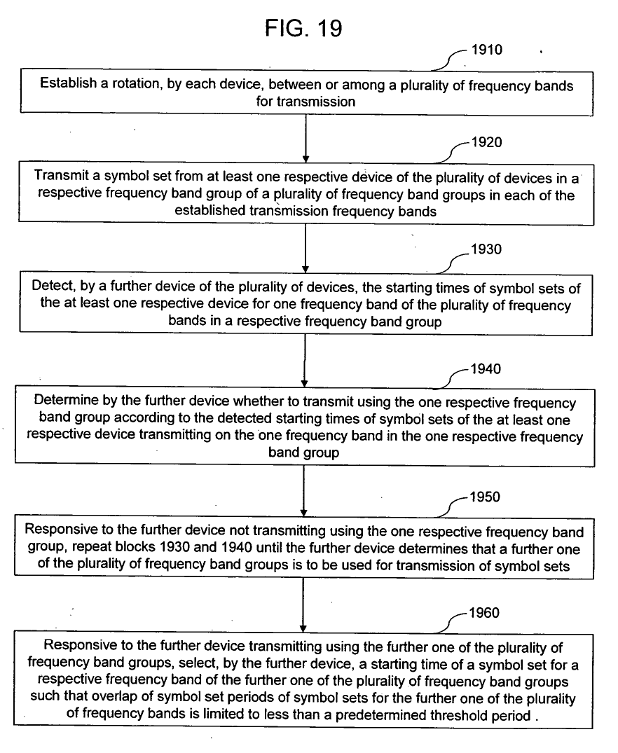

FIG. 19 is a flow chart illustrating a control method of band multiplexing communication in accordance with yet another embodiment of the present invention.

Referring now to FIG. 19, at block 1910, a rotation may be established between or among a plurality of frequency bands for transmission by each of the UWB devices on a multi-band communication system. At block 1920, a symbol set may be transmitted from at least one respective UWB device of the plurality of UWB devices in each respective frequency band group at each of the established transmission frequency bands. At block 1930, the starting times of symbol sets of the at least one respective UWB device for one frequency band of the plurality of frequency bands in a respective frequency band group may be detected by a further UWB device of the plurality of UWB devices.

At block 1940, whether to transmit using the one respective frequency band group may be determined according to the detected starting times of symbol sets of the at least one respective UWB device transmitting on the one frequency band in the one respective frequency band group.

At block 1950, responsive to the further UWB device not transmitting, using the one respective frequency band group, blocks 1920 to 1930 may be repeated until the further UWB device determines that a further one of the plurality of frequency band groups is to be used for transmission of symbol sets.

At block 1960, responsive to the further UWB device determining to transmit using the further one of the plurality of frequency band groups, a starting time of a symbol set for a respective frequency band of the further one of the plurality of frequency band groups is selected by the further UWB device such that overlap of symbol set periods of symbol sets transmitted using the further one of the plurality of frequency bands is limited to less than a predetermined threshold, for example, the predetermined threshold may be any duration less than the band hopping repeat period, and, desirably in a range of about one sample to about one symbol in duration.

Each symbol set may be transmitted for a symbol set period. Moreover, the plurality of frequency bands may repeat transmission after each repeat period. The selection by the further UWB device, at block 1960 may include the setting of a starting time, within each repeat period, of each respective symbol set of the further UWB device for the respective frequency band of the further one of the plurality of frequency bands to (1) at least one symbol set period before or after a starting time of any other respective UWB device; (2) at least one symbol set period before an end of a respective repeat period and (3) after the starting time of the respective repeat period.

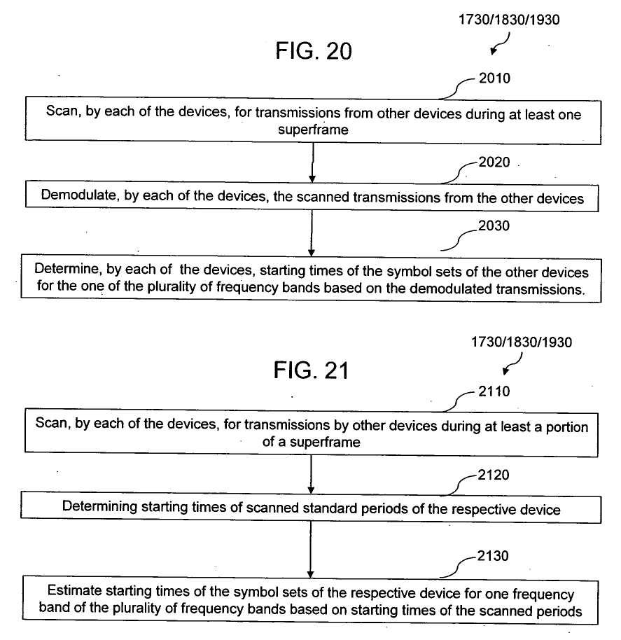

FIG. 20 is a flow chart illustrating the detection operation of FIGS. 17-19 in accordance with various exemplary embodiments of the present invention.

Referring now to FIG. 20, at block 2010, each of the UWB devices may scan for transmissions from other UWB devices during at least one superframe. At block 2020, each of the UWB devices may demodulate the scanned transmissions from the other UWB devices. At block 2030, each of the UWB devices may determine starting times of the symbol sets of the other UWB devices for the one of the plurality of frequency bands based on the demodulated transmissions.

FIG. 21 is a flow chart illustrating the detection operation of FIGS. 17-19 in accordance with various exemplary embodiments of the present invention.

Referring now to FIG. 21A, at block 2110, each of the UWB devices may scan for transmissions from other UWB devices during portions of a superframe. At block 2120, each of the UWB devices may determine if two or more preambles of a standard duration (e.g., which, typically, occur at the beginning of each frame in the superframe) of another UWB device exist in the scanned transmission. At block 2130, each of the UWB devices may determine starting times of the symbol sets of the other UWB device for one frequency band of the plurality of frequency bands based on the determined starting times of the detected preambles. If a signal is detected that includes two or more preambles of frames in a superframe, the starting times of the preambles may be used to determine the starting time of the symbol sets of the other UWB device. That is, by assuming the SST of these preambles follow Equation (2) above, the SST of each symbol set may be determined.

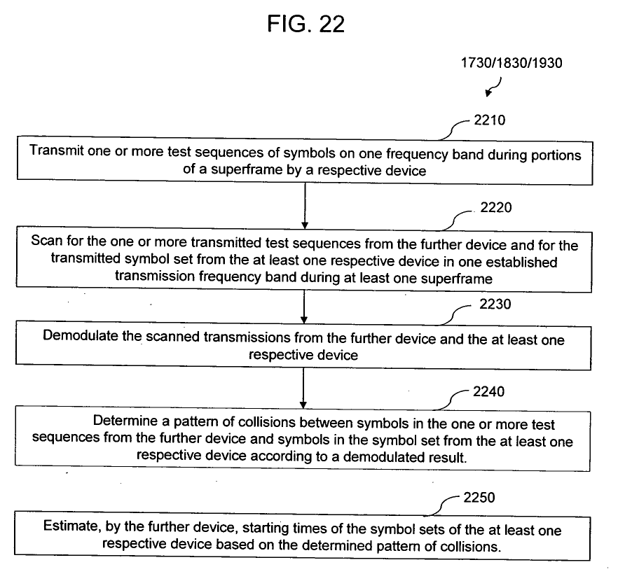

FIG. 22 is a flow chart illustrating the detection operation of FIGS. 17-19 in accordance with various exemplary embodiments of the present invention.

Referring now to FIG. 22, at block 2210, one or more test sequences of symbols on one frequency band may be transmitted during portions of a superframe by the further device. At block 2220, the further device may scan for the one or more transmitted test sequences from the further device and for the transmitted symbol set from the at least one respective device in one established transmission frequency band during at least one superframe. At block 2230, the further device may demodulate the scanned transmissions from the further device and the at least one respective device. At block 2240, a pattern of collisions between symbols in the one or more test sequences from the further device and symbols in the symbol set from the at least one respective device may be determined according to the demodulated result in block 2230.

In some embodiments of the present invention, each UWB device may not be able to simultaneously transmit and receive the test sequences. In such a case, for example, if a first UWB device in a new piconet is trying join (i.e., to reuse) a frequency band with an existing piconet, the first UWB device may transmit the test sequences and a second UWB device on the same piconet may receive the transmitted test sequence (a predetermined sequence) along with any transmission from other UWB devices on the existing piconet. A handshake message including information regarding the SST of the symbol sets from the test sequences and the SIR level of each symbol may be transmitted from the second UWB device to the first UWB device. This information may be used at block 2250 below to establish the starting times of the symbol sets of the first UWB device based on the determined pattern of collisions.

At block 2250, the further device may estimate starting times of the symbol sets of the at least one respective device based on the determined pattern of collisions. That is, the starting times may be estimated by: (1) collisions of the one or more test sequences with symbols of the other UWB devices being detected; (2) collision patterns being established based on the detected collisions; and/or (3) the starting times of the other UWB devices being determined based on the established collision patterns. For example, because of the degradation in the demodulated transmission corresponding to the collision of a test sequence and particular symbols, a boundary representing the starting time of a transmission of symbols may be estimated. Such estimation may be within one symbol duration to allow for “fine” adjustment of the alignment of symbols.

The test sequences may be transmitted in accordance with a repeat period for each device to transmit on the one frequency band such that a repetition period for symbols of the test sequences is variable with a composite period corresponding to the repeat period. That is, the starting time for a respective test sequence corresponding to a particular repeat period may be different from other starting times of other test sequences relative to the other repeat periods for the one frequency band.

According to certain embodiments of the present invention, symbol level band multiplexing in the frequency domain for UWB systems may enables improved band reuse methods over those of conventional UWB systems. Moreover, the use of test sequences enables fine timing adjustments (of less than one symbol) to align a plurality of piconets (for symbol level band multiplexing) that share a common band group to improve or optimize utilization and reuse of each frequency band in the band group.

Although the system has been illustrated as a UWB system, it is contemplated that certain embodiments of the present invention may be applied in other distributed networks (e.g., ad hoc networks) where no central controllers are used.

Although the system has been illustrated using symbol sets of M in duration, it is appreciated by one of skill in the art that the system may operate with symbol set of L symbols per symbol set where L is less than M. That is, the symbol level band multiplexing may be based on a symbol set duration of M symbols such that guard interval between transmissions of UWB devices may be provided to reduce or substantially eliminate collisions between UWB devices, for example between UWB devices of two different piconets. That is, the guard intervals, although it reduces the capacity of each frequency band by M-L/M, may provide protection against collisions from misalignments of, for example one symbol or less.

As is readily understood from these figures, if symbols between UWB devices/channels/SOPs are not aligned, collision patterns may be increased reducing performance of the communication system. Moreover the term “unsynchronized” may refer to a mis-alignment in the timing of a plurality of UWB devices which is a portion of a symbol or more in duration.

Although the invention has been described in terms of a UWB multi-band communication system, it is contemplated that it may be implemented in software on microprocessors/general purpose computers (not shown). In various embodiments, one or more of the functions of the various components may be implemented in software that controls a general purpose computer. This software may be embodied in a computer readable carrier, for example, a magnetic or optical disk, a memory-card or an audio frequency, radio-frequency, or optical carrier wave.

In addition, although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A control method of band multiplexing communications from a plurality of devices in the communication system, a rotation being established, by each device, between or among a plurality of frequency bands for transmission, the method comprising the steps of:
a) transmitting a symbol set from each of the plurality of devices in the communication system in each of the established transmission frequency bands;
b) detecting, by at least one device of the plurality of devices, respective starting times of symbol sets for the other devices transmitting in the communication system for one of the plurality of frequency bands;
c) selecting, by the at least one device, a starting time of a symbol set based on the detected starting times of symbol sets for the other devices, selected start times limiting interference between symbol sets transmitted by the at least one device and the symbol sets transmitted by the other devices to less than a threshold level; and
d) adjusting, by the at least one device, the starting time in subsequent transmissions of respective symbols for each of the established transmission frequency bands based on the selected starting time in step (c).

2. The control method of claim 1, wherein step (b) of detecting, by each of the devices, the starting times on the one of the plurality of frequency bands includes the steps of:
(b-1) scanning, by each of the devices, for transmissions from other devices during at least one superframe;
(b-2) demodulating, by each of the devices, the scanned transmissions from the other devices; and
(b-3) determining, by each of the devices, starting times of the symbol sets of the other devices for the one of the plurality of frequency bands based on the demodulated transmissions.

3. The control method of claim 1, wherein step (b) of detecting, by each of the devices, the starting times on the one of the plurality of frequency bands includes the steps of:
(b-1) scanning, by each of the devices, for transmissions by other devices during at least one portion of a superframe;
(b-2) determining, by each of the devices, starting times of scanned standard periods of a further device; and
(b-3) estimating, by each of the devices, starting times of the symbol sets of the other devices for one frequency band of the plurality of frequency bands based on the determination of the starting times of the scanned standard periods in step (b-2).

4. The control method of claim 1, wherein step (b) of detecting, by each of the devices, the starting times of symbol sets of the other devices on the one frequency band of the plurality of frequency bands includes the steps of:
(b-1) transmitting one or more test sequences of symbols on one frequency band during portions of a superframe;
(b-2) scanning, by each device, for the one or more transmitted test sequences and for the transmitted symbol set from other respective devices in one established transmission frequency band during at least one superframe;
(b-3) demodulating, by each said device, the scanned transmissions from each said device and the other respective devices;
(b-4) determining a pattern of collisions between symbols in the one or more test sequences from each said device and symbols in the symbol set from the other respective devices according to the demodulated result in step (b-3); and
(b-5) estimating, by each said device, starting times of the symbol sets of the other respective devices based on the determined pattern of collisions.

5. The control method of claim 4, wherein step (b-1) is performed by each said device and step (b-2) is performed by a different device such that step (b) of detecting further includes the steps of:
transmitting information regarding the signal to interference level of each symbol of the demodulated scanned transmissions of the one or more test sequences from the different device to enable the determination in step (b-4).

6. The control method of claim 1, wherein the step (b-5) of estimating, by the each said device, the starting times of the symbol sets of the other respective devices based on the determined pattern of collisions includes:
(b-5-1) estimating one or more boundaries delineating collision starting points or collision ending points of symbols between each said device and the other respective devices based on signal to interference levels in time slots of one frequency band corresponding to transmission times of one or more symbols of the one or more test sequences.

7. The control method of claim 1, wherein step (c) of selecting, by each of the devices, the starting time of the symbols et includes the step of:
(b-1) selecting, by each of the devices, the starting time of each of the symbol sets for the one frequency band used for detection in step (b) such that symbol set periods among the devices do not overlap.

8. The control method of claim 1, wherein:
each symbol set is transmitted for a symbol set period and transmission of symbol sets is repeated on each respective frequency band of the plurality of frequency bands according to a repeat period;
step (c) of selecting, by each of the devices, the respective starting time of the symbol set includes the steps of:
(c-1) selecting, by each of the devices, the respective starting time of the symbol set such that the starting time for each respective symbol set of a respective device is at least one symbol set period before or after a starting time of any other device and at least one symbol set period before an end of a respective repeat period.

9. A control method of band multiplexing communications from a plurality of devices in a communication system, a rotation being established, by each device, between or among a plurality of frequency bands for transmission, the method comprising the steps of:
a) transmitting a symbol set from at least one respective device of the plurality of devices in each of the established transmission frequency bands;
b) detecting, by a further device of the plurality of devices, the starting times of symbol sets for one of the plurality of frequency bands for each of the at least one respective devices transmitting in the communication system;
c) determining by the further device whether to transmit using the plurality of frequency bands according to the detected starting times of symbol sets for each of the at least one respective devices transmitting on the plurality of frequency bands; and
d) responsive to the further device determining in step (c) to transmit, selecting by the further device a starting time of a symbol set for the one frequency band used for detection in step (b) such that overlap of symbol set periods for the further device and each of the at least one respective devices transmitting is limited to less than a predetermined threshold level.

10. The control method of claim 9, wherein step (d) of selecting a starting time by the further device includes selecting the starting time such that the symbol set periods for the further device and each of the at least one respective devices transmitting do not overlap.

11. The control method of claim 9, wherein step (b) of detecting, by the further device, the starting times of symbol sets for one of the frequency band of the plurality of frequency bands for each of the at least one respective device includes the steps of:
(b-1) scanning for transmissions from the at least one respective device during at least one superframe;
(b-2) demodulating the scanned transmissions received in step (b-1); and
(b-3) determining starting times of the symbol sets of the at least one respective device for the one frequency band of the plurality of frequency bands based on the demodulated transmissions.

12. The control method of claim 9, wherein step (b) of detecting, by the further device, the starting times of symbol sets for one of the frequency band of the plurality of frequency bands for each of the at least one respective device includes the steps of:
(b-1) scanning for transmissions by the further device during a portion of at least one superframe;
(b-2) determining starting times of scanned standard periods of each of the at least one respective device; and
(b-3) estimating starting times of the symbol sets of each of the at least one respective device for one frequency band of the plurality of frequency bands based on the determination of the starting times of the scanned standard periods in step (b-2).

13. The control method of claim 9, wherein step (b) of detecting, by the further device, the starting times of symbol sets for one of the frequency band of the plurality of frequency bands for each of the at least one respective device includes the steps of:
(b-1) transmitting one or more test sequences by the further device during portions of a superframe;
(b-2) scanning for the one or more transmitted test sequences from the further device and for the transmitted symbol set from the at least one respective device in one established transmission frequency band during at least one superframe;
(b-3) demodulating the scanned transmissions from the further device and the at least one respective device;
(b-4) determining a pattern of collisions between symbols in the one or more test sequences from the further device and symbols in the symbol set from the at least one respective device according to the demodulated result in step (b-3); and
(b-5) estimating, by the further device, starting times of the symbol sets of the at least one respective device based on the determined pattern of collisions.

14. The control method of claim 13, wherein step (b-2) is performed by a first device, different from the further device such that step (b) of detecting further includes the step of:
transmitting information regarding the signal to interference level of each symbol of the demodulated scanned transmissions of the one or more test sequences and information regarding the starting time of the one or more test sequences from the first device to the further device.

15. The control method of claim 13, wherein step (b-1) of transmitting one or more test sequences by the further device during portions of the superframe includes the steps of:
(b-1-1) transmitting one or more test sequences by the further device in accordance with a repeat period for each device to transmit on the one frequency band such that a repetition period for symbols of the one or more test sequences is variable with a composite period corresponding to the repeat period.

16. The control method of claim 13, wherein the step (b-5) of estimating, by the further device, the starting times of the symbol sets of the at least one respective device based on the determined pattern of collisions includes:
(b-5-1) estimating one or more boundaries delineating collision starting points or collision ending points of symbols between the further device and the at least one respective device based on signal to interference levels in time slots of one frequency band corresponding to transmission times of one or more symbols of the one or more test sequences.

17. The control method of claim 9, wherein:
each symbol set is transmitted for a symbol set period and transmission of symbol sets are repeated on each respective frequency band of the plurality of frequency bands according to a repeat period; and
step (d) of selecting, by the further device, the starting time of the symbol set thereof includes the steps of:
(d-1) selecting the starting time of the symbol set of the further device such that the start times of each respective symbol set of the further device for the one frequency band of the plurality of frequency bands is: (1) at least one symbol set period before or after a starting time of any other respective device; (2) at least one symbol set period before an end of a respective repeat period; and (3) after the starting time of the respective repeat period.

18. A control method of band multiplexing communications from a plurality of devices in a communication system, a rotation being established, by each device, between or among a plurality of frequency bands in a frequency band group for transmission, the communication system including a plurality of frequency band groups, the method comprising the steps of:
a) transmitting a symbol set from at least one respective device of the plurality of devices in a respective frequency band group of the plurality of frequency band groups in each of the established transmission frequency bands;
b) detecting, by a further device of the plurality of devices, the starting times of symbol sets of the at least one respective device for one frequency band of the plurality of frequency bands in the respective frequency band group;
c) determining, by the further device, whether to transmit using the one respective frequency band group according to the detected starting times of symbol sets of the at least one respective device transmitting on the one frequency band in the one respective frequency band group;
d) responsive to the further device determining in step (c) not to transmit using the one respective frequency band group, repeating steps (b) and (c) until the further device determines that a further one of the plurality of frequency band groups is to be used for transmission of symbol sets; and
e) responsive to the further device determining in step (d) to transmit using the further one of the plurality of frequency band groups, selecting, by the further device, a starting time of a symbol set for a respective frequency band of the further one of the plurality of frequency band groups such that overlap of symbol set periods of symbol sets for the further one of the plurality of frequency bands is limited to less than a predetermined threshold period.

19. The control method of claim 18, wherein step (b) of detecting, by the further device, the starting times of the symbol sets of the at least one respective device for the one frequency band of the plurality of frequency bands includes the steps of:
(b-1) scanning for transmissions from the further one respective device during at least one superframe;
(b-2) demodulating the scanned transmissions received in step (b-1); and
(b-3) determining starting times of the symbol sets of the at least one respective device for the one frequency band of the plurality of frequency bands based on the demodulated transmissions.

20. The control method of claim 18, wherein step (b) of detecting, by the further device, the starting times of the symbol sets of the at least one respective device for the one frequency band of the plurality of frequency bands includes the steps of:
(b-1) scanning for transmissions by the further device during at least one a portion of superframe;
(b-2) determining starting times of scanned standard periods of the at least one respective device; and
(b-3) estimating starting times of the symbol sets of the at least one respective device for one frequency band of the plurality of frequency bands based on the determination of the starting times of the scanned standard periods in step (b-2).

21. The control method of claim 18, wherein step (b) of detecting, by the further device, the starting times of the symbol sets of the at least one respective device for the one frequency band of the plurality of frequency bands includes the steps of:
(b-1) transmitting one or more test sequences of symbols on one frequency band during portions of a superframe;
(b-2) scanning for the one or more transmitted test sequences and for the transmitted symbol set from the at least one respective device in one established transmission frequency band during at least one superframe;
(b-3) demodulating the scanned transmissions from the further device and the at least one respective device;
(b-4) determining a pattern of collisions between symbols in the one or more test sequences from the further device and symbols in the symbol set from the at least one respective device according to the demodulated result in step (b-3); and
(b-5) estimating, by the further device, starting times of the symbol sets of the at least one respective devices based on the determined pattern of collisions.

22. The control method of claim 21, wherein step (b-2) is performed by a first device such that step (b) of detecting further includes the steps of:
transmitting information regarding the signal to interference level of each symbol of the demodulated scanned transmissions of the one or more test sequences from the first device to the further device.

23. The control method of claim 21, wherein the step (b-5) of estimating, by the further device, the starting times of the symbol sets of the at least one respective device based on the determined pattern of collisions includes:
(b-5-1) estimating one or more boundaries delineating collision starting points or collision ending points of symbols between the further device and the at least one respective device based on signal to interference levels in time slots of one frequency band corresponding to transmission times of one or more symbols of the one or more test sequences.

24. The control method of claim 18, wherein:
each symbol set is transmitted for a symbol set period and transmission of symbol sets are repeated on each respective frequency band of the plurality of frequency bands according to a repeat period; and
step (e) of selecting, by the further device, the starting time of the symbol set thereof includes the step of:
(e-1) selecting the starting time of the symbol set of the further device such that starting times of each respective symbol set of the further device for the respective frequency band of the further one of the plurality of frequency bands is: (1) at least one symbol set period before or after a starting time of any other respective device; (2) at least one symbol set period before an end of a respective repeat period and (3) after the starting time of the respective repeat period.

25. A device for communicating with at least one other device, comprising:
a processor for establishing the rotation between or among a plurality of frequency bands;
a transmitter for transmitting a symbol set in each of the established transmission frequency bands; and
a receiver for detecting respective starting times of transmitted symbol sets from the at least one other device for one of the plurality of frequency bands, wherein the processor selects a starting time of a symbol set to be transmitted based on the detected starting times of symbol sets of the at least one other device, and controls the adjustment of the starting time by the transmitter in subsequent transmissions of respective symbols for each of the established transmission frequency bands based on the selected starting time, the selected start time being selected to limit interference between symbol sets transmitted by the device and the symbol sets transmitted by the at least one other device to less than a threshold level.

26. A computer readable medium including software that is configured to control a general purpose computer to control communication from a device in the communication system by implementing a method according to claim 1.
